(19) United States
(12) Patent Application Publication
(10) Pub. No.: US 2002/0054428 A1
(43) Pub. Date: May 9, 2002

(54) Method and system for aligning and optical system via single axis adjustments

(76) Inventor: George H. Seward, Arlington, MA (US)

Correspondence Address: CESARI AND MCKENNA, LLP, 88 BLACK FALCON AVENUE, BOSTON, MA, 02210, US

(21) Appl. No.: 09/816,826

(22) Filed: Mar. 23, 2001

Related U.S. Application Data
(60) Provisional application No. 60/219,624, filed on Jul. 21, 2000.

(51) Int. Cl. G02B 26/08; G02B 1/00; G02B 3/02; G02B 13/18

(52) U.S. Cl. 359/362; 359/434; 359/709; 359/210

(57) ABSTRACT

An optical procedure and system for aligning a beam of light to an optical fiber is described. The beam may originate from a diode laser, a light emitting diode, a collimated laser, or an optical fiber. The system controls as many as eight degrees of freedom of the beam incident upon the fiber. The system employs optical leverage to relax assembly tolerances while still achieving the necessary fine tolerances for singlemode fibers. The adjustments are achieved by translation of components along a single direction across the optical axis and along a flat planar base on which the elements are mounted. The optical leverage, the single direction of translation, and the flat-base interface are features that facilitate automated assembly of fiberoptic packages. Planar graded index of refraction lenses are used in a preferred embodiment that enhances the optical coupling efficiency by practically eliminating the reflections at component interfaces.

### CROSS-REFERENCE TO RELATED APPLICATIONS

The present application claims priority from:

U.S. Provisional Patent Application Serial No. 60/219,624, which was filed on Jun. 21, 2000, by George H. Seward for a Method and System for Aligning Optical Fiber Delivery System; and

U.S. Provisional Patent Application, Serial No. ______ which was filed on Nov. 13, 2000, by George H. Seward for a Specification of Method for Alignment of Fiber Delivery System and Required Design Specification, and

U.S. Provisional Patent Application, Serial No. ______ which was filed on Dec. 1, 2000, by George H. Seward for a Design Specification of Fiber Delivery System with Three-Or-Five Orthogonal Spatial Adjustments Preformed by Translation along a Single Transverse Axis, and

U.S. Provisional Patent Application, Serial No. ______ which was filed on Dec. 11, 2000, by George H. Seward for an Astigmatic Graded-Index Lens for Collimation of Laser-Diode Beams.

All the above applications are hereby incorporated herein by reference.

The present invention is related also to U.S. patent application, Ser. No. 09/754883, which was filed on Jan. 5, 2001, for a Method and System for Aligning Optical Fiber Delivery System, and having the same inventor and ownership as the present invention. This application is hereby incorporated herein by reference.

### BACKGROUND OF THE INVENTION

1. Field of the Invention

The present application relates to optical fiber information transmitting systems carrying laser beams, and more particularly to optically aligning the laser beams to the optical fibers.

2. Background Information

The increase in the demand for ever higher speeds of signal transmission with ever higher signal capacities has hurried the use of lasers and optical fibers for carrying high speed transmissions. These laser optical coupling assemblies are becoming common throughout the world. Certainly, the well-known limitations of copper lines (higher volume-and-weight and lower signal speeds-and-capacities) and satellites (high cost and speed limitations of the atmosphere and problems due to weather) for signal transmissions enhance the popularity of laser fiber optics. The laser/fiber transmission system is essentially a laser beam (or several beams) that can be modulated to carry information that is targeted on and coupled to an end of an optical fiber that takes the information-carrying beam to the outside world.

An initial problem associated with these assemblies is the alignment of the laser beam and the end of the optical fiber. The design and manufacturing of the laser optical devices must be cost competitive and easily maintained. However, the alignment accuracy and precision must be preserved. Many such assemblies are not easily implemented in the mass production rates required to meet the growing demand for components.

The following describes and defines artifacts, concepts, tolerances and other such technical background items that provide better understanding of the present invention.

Singlemode and Multimode Fibers

A singlemode fiber permits only one mode of propagation. This single mode is Gaussian shaped in its radial profile. There is no radial motion of the beam as it propagates down the singlemode fiber. Consequently, photons of the same wavelength all experience same time-of-flight through the fiber. This feature of the singlemode fiber is extremely desirable for maximizing the bandwidth of the fiber. Temporal bandwidth determines the maximum number data-carrying channels within the frequency spectrum of the modulated power of the beam.

A multimode fiber supports numerous paths of propagation within its core. The time-of-flight for each mode is slightly different from many others. Consequently, a temporal blurring occurs over long distances. As the length of the multimode fiber increases so does the temporal spread, and consequently the temporal bandwidth is reduced. Multimode fibers are out of favor in current system designs.

The diameter of the single mode profile is typically seven times the wavelength of the light employed. Sources available for practical application are not much greater than 1.5 um in wavelength. Consequently, the practical limit to the diameter of single mode fiber is 10 um or less.

Coordinate System

A coordinate system is defined for the purposes of this disclosure as an x, y, and z coordinate system. These axes form the well-known three-dimensional Cartesian coordinate systems. They are featured in most of the drawings. The z-axis 120 is coincident with the optical axis. An axial position refers to distance along the z-axis. The x-axis 122 is parallel to the plane of the optical base to which the components are mounted. The y-axis 124 is perpendicular to the optical base. The angular orientations are pitch, yaw, and roll. The pitch is defined as the rotation about the x-axis.. The yaw is defined as rotation about the y-axis, or more specifically the angle with respect to the z-axis within the axial plane orthogonal to the y-axis. The roll is defined as the rotation about the z-axis or more specifically the radial angle.

The terms axial and radial have specific meanings within the coordinate system of this application. A radial position is the distance from the z-axis within the x-y plane. A radial plane is parallel to the x-y plane. A radial angle is the angle within the radial plane with respect to the x-axis. Opposite radial angles are separated by 180 degrees. An axial position is the position along the z-axis. An axial plane is parallel to the z-axis. Axial planes are always perpendicular to radial planes. An axial angle is the angle with respect to the z-axis within an axial plane.

Two axial angles defined by orthogonal axial planes represent a complete description of direction. Pitch and yaw are examples of two such axial angles. Other sets of orthogonal axial planes are oriented at finite radial angles with respect to the axial planes of pitch and yaw. Furthermore, the axial planes of the two axial angles of the complete set are not necessarily orthogonal, but they must not be parallel. This distinction is very important to the configurations of the invention.

Degrees of Freedom in Laser Fiber Delivery Systems

Optimum delivery of the laser into the fiber requires optimization of eight independent parameters of the beam at the fiber, as shown in the following table. These parameters are orthogonal (or independent) to each other because each one does contain any portion of the others. The term orthogonal is frequently used to describe perpendicular vectors. Each parameter represents one degree of freedom (DOF) in the optical system. There are up to eight DOFs addressed by the various configurations of this invention.

| Parameter at fiber | Symbol |
|---|---|
| position of beam along x | x |
| position of beam along y | y |
| axial position of x-axis waist | zₓ |
| axial position of y-axis waist | z_{y} |
| dimension along the x-axis | φₓ |
| dimension along the y-axis | φ_{y} |
| Pitch of wavefront | P |
| Yaw of wavefront | Y |

The x and y positions of beam describe the radial position of the beam's axis of propagation at the fiber end. The two z-positions describe the axial locations of the two orthogonal waists. A beam waist is analogous to the focal point of converging beam (more on this later). The dimensions along the x- and y-axes describe the distances between the 1/e² points of the irradiance profile across the respective axes. The pitch and yaw describe the direction of the beam at the fiber. More specifically, the direction is defined by the normal to the wavefront at the radial center of the beam (more on this later).

A beam does have two more degrees of freedom: phase of the electric field along x, and phase of the electric field along y. The relative phase of the two components is the polarization of the beam. Its absolute phase is not measurable by present day technology, but it can be measured with respect to another beam by interference with the other beam. These two degrees of freedom are not addressed by the invention of this application

The flat wavefront along the x-axis is not necessarily coincident with the flat wavefront along the y-axis. Therefore, these two orthogonal waists can have different axial positions. In such a situation, the wavefront is cylindrical at the location of either waist. Henceforth, this is referred to as an astigmatic wavefront. However, at some point along the beam, this astigmatic wavefront becomes symmetrical at one and only one axial position on either side of the waist.

The radial dimensions of the beam are not necessarily equal. A collimated beam can have an elliptical profile within the radial plane. Henceforth, this is referred to as an astigmatic profile. However, at some point along the beam, this astigmatic profile becomes symmetrical at one and only one axial position on either side of the waist.

Complete Sets of Vectors

A complete set of vectors provides the necessary components for a complete description of the relevant degrees of freedom. Normally these vectors are orthogonal, but that is not necessary. Navigation on flat surfaces is now discussed as applications of orthogonal and non-orthogonal complete sets.

Ordinarily, the orthogonal vectors of north and east are used as a complete set of vectors for navigation on flat land. Neither vector contains any component of the other—therefore, they are orthogonal. Navigation to a single point can be accomplished in two orthogonal steps: first, travel along north, and second, travel along east. This two-step process is consistently achieved only with two orthogonal vectors.

However, a complete set of vectors need not be orthogonal. The vectors north and northeast also form a complete set. Each vector contains a portion of the other—therefore, they are not orthogonal. Consequently, a two-step navigation is not likely. A more likely sequence of travel along these vectors is an iteration of two steps: first, travel along north; and second, travel along northeast. Each iteration reduces the error in position. Typically, the error is reduced in a geometric manner, and the procedure requires only three or four iterations.

Any two vectors can be used to form a complete set, as long the vectors are not parallel or redundant to each other. Even such vectors as north and one-degree east of north form a complete set. However, such close similarities in vectors can require numerous iterations. It is best to choose vectors that are nearly orthogonal, such as north and one-degree north of east.

The translations within the claimed devices of this application always form complete sets. The specifications of the claimed devices avoid nearly redundant vectors, unless the redundant vector provides a different leverage between a translation and its effect upon a degree of freedom.

Gaussian Laser Beams

A Gaussian laser beam has two important intrinsic properties when focused at the entrance to a singlemode fiber: the beam diameter and the wavefront curvature. These is features are described.

The Gaussian beam has an irradiance profile described by

$$I = \frac{8 {P}_{0}}{{πφ}^{2}} exp ( \frac{- 8 {r}^{2}}{{φ}^{2}} ) ,$$

in which, P₀ is the optical power of the beam, Φ is the beam diameter, and r is radial position from beam's axis of propagation. The beam diameter is expressed as

Φ²=Φ₀²+β² (z−z₀)²,

in which Φ is diameter of the beam waist, β is the full angle of beam divergence for the beam diameter, z is the position along the axis of propagation, and z₀ is the position of the beam waist along z. The beam waist and beam divergence diameter are related by the following space-angle product:

$${φ}_{0} β = \frac{4}{π} λ = \frac{λ}{{π}_{4}} ,$$

in which λ is the wavelength of the electromagnetic wave of the traveling laser beam, and π₄ is a convenient abbreviation for π/4.

This relationship still applies within a refractive medium because both β and λ are reduced by the index of refraction.

The waist diameter of a focused beam, Φ₀, is directly related to the diameter of the beam at the focusing lens, Φ_{L}, by the space-angle product.

$${φ}_{0} β = {φ}_{0} \frac{{φ}_{L}}{f} = \frac{λ}{{π}_{4}} ,$$

in which f is the focal length of the lens. Rearrangement of terms reveals this dependency of the focused beam waist diameter upon the incident beam diameter.

$${φ}_{0} = \frac{λ}{{π}_{4}} \frac{f}{{φ}_{L}} .$$

Manipulation of the input beam diameter is essential for matching the diameter of the beam at the fiber to the diameter of the single mode of the fiber.

The wavefront of the traveling beam refers to a two-dimensional surface that corresponds to the position of the maximum electric field within a single cycle of the electromagnetic wave. For a circularly symmetric beam profile, the wavefront is coincident with a sphere whose radius changes throughout the axis of propagation. The radius of this wavefront is described as

$$R = \frac{{φ}^{2}}{{β}^{2} ( z - {z}_{0} )} .$$

At the beam waist, the radius is infinite. This corresponds to a flat wavefront. As the distance from the waist increases, the radius reaches a minimum magnitude. This minimum occurs at the Raleigh distance. It is expressed as

$${z}_{R} = \frac{{π}_{4} {φ}_{0}^{2}}{λ} .$$

The corresponding radius of the wavefront is twice the Raleigh distance.

A flat wavefront at the fiber is important at the fiber input, because the wavefront of the single mode of the fiber is also flat. The wavefront should also be normal to the axis of the fiber.

Absolute Convergence

Convergence describes the angle at which the beam is converging. Mathematically, it is the negative of the angle of divergence. The polarity of convergence switches for a beam traveling in the opposite direction. This issue of polarity is solved by referencing the absolute value of the convergence. Henceforth, the absolute value of the convergence is referenced as absolute convergence.

The absolute convergence is employed to avoid reference to a collimated beam, because a collimated beam is not physically realizable. A Gaussian beam cannot have zero divergence due to the space-angle product of a Gaussian beam. Avoiding a nearly collimated beam is important to elements of this application. Thus, the absolute convergence is employed a physical parameter that quantifies deviation from a nearly collimated beam. A larger absolute convergence specifies a larger deviation from collimation.

Tolerance and Specifications

The specification and tolerance requirements of the industry regarding the physical particulars of the fibers and the lasers involved require alignments accurate to +/−0.1 microns (um). That is the laser beam must be focused on the end of the fiber within this tolerance to ensure reasonable coupling efficiency (loss of 5% or 0.25 dB with a 0.1 um of radial misalignment). An article published at the year 2000 Electronic Components and Technology Conference by Soon Jang of the Newport Corporation discusses the current issues and processes regarding manufacture of laser optical couplers to the needed accuracy and precision, this article is hereby incorporated herein by reference.

The required tolerance along z is typically much larger than along a radial position. For example, a beam with a wavelength of 630 nm and a waist of 4.5 um has a Raleigh range of 25 um. One-tenth of the Raleigh distance was sufficient for less than 1% loss in a prototype with above parameters.

The wavefront error due to a tilt at the fiber is approximated as

λ_{ET}=Φ_{M}θ_{W},

in which Φ_{M} is the diameter of the Gaussian mode of the fiber, and θ_{w} is the angle of the wavefront normal with respect to the axis of the fiber. Typically, the diameter of a single mode field pattern is seven times that of the wavelength. The actual pattern extends beyond this diameter, thus an effective diameter of 10 times the wavelength is a fair approximation.

Φ_{M}≈10 λ.

The resulting wavefront error due to tilt becomes

λ_{ET}=10 θ_{W} λ.

A wavefront error of less than one-tenth of one-wavelength is considered acceptable for all practical applications. Such an error in wavefront tilt requires that θ_{W}≦10 mrad.

A properly focused Gaussian beam is displayed in FIG. 1A. The incident Gaussian beam 301 is portrayed by the propagation of its outer edges of its beam diameter. The optical axis 302 matches that of the fiber, not shown. The converging lens 303 focuses the beam to a flat wavefront 304 at its waist. The flat wavefront 304 is represented as a straight line. An arc 305 represents the wavefront at the Raleigh distance. The radius of this arc is proportionally correct in this figure for beam waist diameter of 8 um and wavelength of 0.8 um. Near the lens, a wavefront 306 has a radius centered on the beam waist.

In FIG. 1B, the incident beam 307 is off-axis in space. The transverse error in the position of the beam creates a tilt of the wavefront 308 at the fiber. This tilt due to the radial collimation error is

$${θ}_{RCE} = \frac{- {r}_{CE}}{f} ,$$

in which r_{CE} is the radial distance of collimation error, and f is the focal length of the lens.

In FIG. 1C, the incident beam 309 is off-axis in angle. This angle of collimation error creates a tilt of the wavefront 310 at the fiber. This tilt created by the angular collimation error is equal to the angle of collimation error

θ_{ACE}=θ_{CE},

in which θ_{CE} is the angle of collimation error. The total error in angle of the wavefront created by collimation error is

$${θ}_{WCE} = \frac{- {r}_{CE}}{f} + {θ}_{CE} .$$

From the above equation, it is easily observed that the wavefront angle is zero when

r_{CE}=θ_{CE}f.

In this condition, the axis of the beam travels through the front focal point of the lens. Subsequently, the lens focuses the beam to a point with a radial position equal to r_{CE}. The wavefront error at this off-axis focal point is zero.

Prior Art for Correction of 6 DOFs

FIG. 2 displays an existing solution to the problem of matching six DOFs of the beam to the fiber. A beam 202 originating from a source 204 is collimated by a collimating lens 206 and focused by a focusing lens 208 onto the end of a fiber 210. The z-position of the collimating lens 206 establishes the beam diameter at the focusing lens 208, which in turn establishes the beam waist diameter at the fiber 210. The x- and y-positions of the collimating lens determine the pitch and yaw of the wavefront at the fiber. The x- and y-positions of the focusing lens determine the x- and y-positions of the beam at the fiber. Lastly, either the z-position of the focusing lens or the z-position of the fiber determines the axial location of the beam waist relative to the fiber. These 6 degrees of freedom (DOFs) must be optimized for maximum coupling efficiency. This type of system does not address the desired eight DOFs of the present invention because the orthogonal dimensions of the beam waist are not independently addressed, and the axial positions of the orthogonal beam waists are not independently addressed.

Both the collimating lens and the focusing lens must be manipulated in the x, y, and z directions as part of search algorithm that drives the system towards local maximum (the z direction of the focussing lens can also be managed motion of the fiber along z). Such an algorithm is not easily managed, because the manipulation and fixation of a lens along two or three degrees of freedom is not an easy task. It is successfully employed with determined effort

Laser Diodes

Diode lasers are both small and cost-effective for fiberoptic systems. Both gas lasers and solid-state lasers are not practical for fiberoptic systems because of their size and expense. They are employed in free-space optical communication systems. Diode lasers are the industry standard for fiberoptic communications.

A laser diode is basically a light emitting diode within a resonating cavity. The photons are emitted from the junction between the p- and n-type materials. The resonating cavity promotes stimulated emission of photons along a single mode of the cavity. Consequently, most of the light escapes from the cavity while propagating along the single mode of the laser diode.

The cross-section of the resonator of a laser diode is not symmetrical. The depletion region of the p-n junction determines the smaller dimension of the cavity's cross-section. There is a limit to the maximum value of this height based upon the physical properties of the semiconductors employed. Therefore, this resonator height cannot be much larger than 1 um. The orthogonal dimension of the cross-section, referred to as the width, can be much larger than the height. An example of high power diode laser for communications is the 100-milliwatt L9801E2P5 by Thorlabs. It has an emitter cross-section of 1 um by 3 um.

The maximum output power of a diode laser scales linearly with the area of the resonator's cross-section. The output power is scaled by the width of the resonating cavity, but the height is fixed. Consequently, maximizing output power requires an asymmetric beam profile. This profile is an elliptical Gaussian pattern.

An elliptical Gaussian beam does not couple efficiently into a single-mode optical communications fiber. Single-mode fibers are normally circular in cross-section. Therefore, considerable effort is made to eliminate the asymmetry of a diode laser beam at the fiber.

The asymmetry of the laser beam is further complicated by propagation of the beam. The divergence of the beam is also asymmetric. Consequently, the asymmetry of the profile changes over distance. Furthermore, the curvature of the wavefront is also asymmetric, and its asymmetry changes over distance. Consequently, the axial separation of the orthogonal waists created by a focusing lens is very dependent upon the axial position of the lens.

In summary, the emerging beam from a laser diode is consistently astigmatic in both profile and wavefront. These parameters must be transformed into the optimum values of four parameters at the fiber: axial position of the waist along x, axial position of the waist along y, the dimension of the waist along x, and the dimension of the waist along y. This conversion of two pair of astigmatic variables at the laser into two pair of symmetrical parameters at the fiber always requires four degrees of freedom in the optical system for coupling. Failure to completely correct one or both astigmatisms will reduce coupling efficiency.

Many solutions for collimation of astigmatic beams exist today. The practical solutions do not provide neither dynamic nor independent adjustments of the orthogonal parameters of beam waist locations and dimensions.

Optical Wedges

A wedge is frequently used for creating a small deflection of a beam. Radial rotation of the wedge about the optical axis sweeps the exiting beam around the optical axis. A pair of wedges is frequently cited for adjustment of the pitch and yaw of the exiting beam. The radial angle of the two wedges as a whole controls the radial angle of the exiting beam. This application is relevant to optical scanners. The separation of two wedges can also be employed to shift the radial position of an exiting beam without a change in direction.

Radial translation of a wedge is not frequently cited, although it does appear to be an obvious solution to problem of fine adjustments to focus. At present, a set of axially translating wedges is employed by Microcosm (PAT PEND) for dynamic modulation of polarization.

The radial translation of a wedge creates a much smaller axial translation of the focused spot at the fiber. The translation of a wedge does induce a small radial shift. Radial translation of the wedge lens creates a much smaller axial translation of the focused spot at the fiber. This axial leverage is expressed mathematically in two forms.

Axial Leverage

The first form of axial leverage is based upon a wedge of constant index of refraction, where the longitudinal leverage is expressed as

$${L}_{L} = \frac{{n}_{W}}{{θ}_{W}} ,$$

in which n_{W} is the index of the wedge, and θ_{W} is the angle of the wedge. A desirable axial leverage is 50. Thus, a 10-um longitudinal motion at the fiber is created by 500 um of transverse motion of the wedge. This is achieved by an average index of 1.5, and wedge angle of 30 milliradians.

The second form of axial leverage is based upon a wedge of constant thickness

$${L}_{L} = \frac{{n}_{W}^{2}}{{d}_{W} {m}_{W}} ,$$

in which n_{W} is the local index of the wedge, d_{W} is the uniform thickness of the wedge, and m_{W} is slope of the index change along the y-axis. A desirable longitudinal leverage is 50. Thus, a 10-um longitudinal motion at the fiber is created by 500 um of transverse motion of the wedge. This leverage is achieved by the following parameters: an average index of 1.5, a uniform thickness of 1.0 mm, and a slope of 0.045 refractive-index-units per mm.

Radial Optical Leverage

The term optical leverage refers the motion of a focused spot created by the motion of a lens. The leverage created by single lens is unity. FIG. 3 shows a weak lens 102 used in conjunction with strong lens 104 that creates leverage much greater than unity. The shift 112 of the focused spot 105 is smaller than the shift 110 of the weak lens. This ratio is equal to the magnitude of the ratio the two focal lengths. After passing though the weak lens, the beam appears to originate from the focal point of the weak lens 106. Radial translation 110 of the weak lens creates a translated virtual origin 108 of the beam and a translation 112 of the focused spot. The focal lengths of the strong and weak lenses are f_{S} and f_{W} respectively. The position of the virtual origin is at a distance of f_{W} from the strong lens. If |f_{W}|>>|f_{S}|, then the transverse magnification is

$${M}_{T} = \frac{{f}_{W}}{{f}_{S}} .$$

The optical radial leverage is the absolute value of this

$${L}_{R} = \vert \frac{{f}_{W}}{{f}_{S}} \vert .$$

In FIG. 3, the graphics are an actual ray trace through lenses with focal lengths of −100 mm and 20 mm. This creates a radial leverage of 5. Thus, as seen in FIG. 3, a 5-mm translation 110 by the weak lens creates a 1-mm translation 112 of the focused spot.

Other Fiber Delivery Systems in Prior Art

There are a number of patents relating to focusing and aligning lasers to the ends of optical fibers. On such patent by Lynch et al. is U.S. Pat. No. 5,077,622 ('622). This patent, which is hereby incorporated herein by reference, discusses the adjustments needed for aligning a polarized laser onto the core of an optical fiber. Those adjustments are 1) the beam polarization, 2) the diameter of the beam waist at the target (the end of the fiber), 3) the x and y transverse position of the beam waist with respect to the target, 4) the z axis (the optical axis) position of the beam waist to the target, and 5) the angle of the beam waist in the x and y directions relative to the target. In this patent application, the laser beam is defined relative to a Gaussian beam as is known in the field, and discussed below. The '622 patent provides for focusing and positioning the beam waist at a desired location with respect to the target fiber end. The physical system uses multiple lenses that move both along and across the optical axis, and it also employs optical devices that rotate about radial axes.

The '622 patent also defines “optical leveraging” where the resolution of the associated mechanical devices is relaxed compared to the resolution required for proper alignment of the laser beam to the fiber end. The '622 patent and the present invention are drawn to the alignments 2), 3), 4) and 5) listed above. The required methods for polarization and are well known in the field.

The '622 patent controls the radial position of the beam on the target by radial motion of a lenses that is weak in optical power in comparison that of the strong focusing lens. The ratio of the two optical powers determines the “optical leverage” obtained. Two rotating plane-parallel plates control the angle of the wavefront normal at the target. Each plate rotates about one of the two orthogonal radial axes. The tilt of a plate controls the radial displacement of the beam at the focusing lens. This displacement is then converted into the angle of the wavefront normal at the fiber. The diameter of the beam at the fiber is controlled by the axial separation of a diverging lens from the focusing lens. The location of the beam waist is controlled by axial translation of the focusing lens.

Thus, the Lynch patent successfully addresses the alignment of two radial positions, one axial position, and one symmetric diameter. It does not correct for astigmatism in the beam. Furthermore these adjustments are accomplished by not one but several methods of translation and tilt. The new device of this article employs a single axis translation as the sole method of modifying all of the aforementioned parameters.

The '622 patent also refers to fiber couplers from the Newport Corp., catalog No. 100 (part numbers L-1015 and L-1015LD) where fiber couplers are shown with adjustment capabilities including lenses that are moved transversely to the optical axis that help position the beam onto the target.

The Newport catalog discloses “optical leverage” by radial motion of a weak lens. However, these devices employ translation of optical elements along three orthogonal axes.

OZ Optics manufactures a device for delivery of free-space lasers into singlemode fibers. The device employs a tiltable mount for the fiber end. Three axial screws adjust the tilt of the fiber. The focusing lens is centered within the triangular pattern of the axial screws. The tilt creates a small radial motion the fiber that is much smaller than the axial translation of the screws. Thus, axial motion of screws creates radial motion of the fiber end by means of a strictly mechanical linkage. Various patents exist on the OZ technology. The axial focus is controlled by axial motion of a focusing lens.

Many companies such as Newport, Thorlabs, and Nu Focus provide standard products for delivering laser beams into singlemode fibers. These products employ translation stages. Typically, the tilt of the wavefront at the fiber is adjusted by tilting the fiber. Furthermore, the axial focus is controlled by axial motion of a focusing lens or the fiber. Radial motion of the spot on the fiber is controlled by a parallel radial motion of either a focusing element or the fiber. These systems employ multiple orthogonal axes of translation.

None of these existing solutions addresses the desired eight DOFs of the present invention because the orthogonal dimensions of the beam waist are not independently addressed, and the axial positions of the orthogonal beam waists are not independently addressed.

Three Axis System With Orthogonal Motion

Cylindrical lenses have long been used for management of astigmatic beams. A pair of crossed cylindrical lenses is frequently employed to create an elliptical spot from a circular input beam. Independent motion of each lens across its focal axis is an obvious method of adjusting the position of the focused beam along the orthogonal radial axes.

Traditionally, the motion of each cylindrical lens has been perpendicular to its focal axis. The corresponding position along its focal axis has not been important. Only translation across a focal axis has been considered critical. Translation of a cylindrical lens at other angles has not been displayed as beneficial in the past.

Lens Technologies

Several forms of lenses are employed to collimate and converge light into singlemode fibers. They employ not only surface profiles but also index profiles. The term index refers to the index of refraction. The index determines both the wavelength and the velocity of the beam within the medium. The variation in velocity is responsible for a change in direction. This change in direction is called refraction. The optical strength of a lens is called the power of the lens. It is the reciprocal of is focal length.

The most basic form of a lens is one of uniform index with convex surface contours at the entrance and exit faces. The curved surface profile of this lens bends the light only at the interface of the glass and air. The surface profile can have many forms. For example, it can be the surface of a cylinder, which converges collimated light to a single focal axis. Henceforth, a lens of this type is called a one-axis lens or a single axis lens because it focuses light only along one axis. A lens with radially symmetric surface profiles, such as a sphere, converges collimated light to a single focal point. Henceforth, a lens of this type is called a two-axis lens because it focuses light along two orthogonal axes. A two-axis lens can be asymmetrical. Such a lens has two focal axes that are perpendicular in angle within the radial plane while offset in axial position. If the radial profile becomes symmetric then the two focal axes combine to form a single focal point.

Spherical and cylindrical surfaces do not converge light in a perfect manner because a spherical surface is not a perfect solution to the problem. Actually, an aspheric profile is the perfect solution. In such a lens, the spot size is limited by the diffraction of the traveling wavefront. In terminology of the art, an aspheric lens creates a diffraction-limited wavefront at the fiber input. This is essential for optimum delivery of a laser beam into a singlemode fiber.

A second type of lens employs a radial graded index to bend the light throughout the volume of the lens. Such a lens can have planar entrance and exit faces. They are frequently called graded index lenses or GRIN lenses. A two-axis GRIN lens is typically cylindrical in shape with flat ends serving as the entrance and exit faces. A one-axis GRIN lens is typically shaped as a block with orthogonal faces. Although the one-axis GRIN lens does not have a cylindrical index profile, it is frequently called a graded index cylindrical lens. In this article, this misnomer is avoided when possible.

A third type of lens employs an axial graded index in conjunction with a surface profile. Such a combination corrects the chromatic aberrations originating from the variation in index with electromagnetic wavelength. Other hybrid combinations exist. A radially symmetric two-axis GRIN lens can employ a cylindrical surface profile. Such a lens corrects the astigmatism of a laser diode during collimation.

Various examples of astigmatic lenses are available today. Details of several examples are as follows.

The company BlueSky Research provides a laser that employs a single cylindrical lens to circularize the beam by equalizing the wavefront curvature at an axial position where the profile is symmetric. This lens is made of glass with uniform index.

The company NSG provides a lens that corrects the astigmatism in wavefront. The NSG brand of graded index lens is known as a Selfoc lens. The version for correction of astigmatism has a cylindrical surface profile on the exit face. The cylindrical exit surface corrects the astigmatism in wavefront at an axial point where the beam is round. This lens effectively corrects astigmatism in both wavefront and profile, but not in a dynamic manner. Therefore, it cannot consistently eliminate all of the astigmatism, if that astigmatism has a variance due to fabrication procedures of the laser diode.

The company Grintech manufactures graded index single-axis lenses for collimating the fast of a laser diode. When combined with an orthogonal graded index single-axis lens, this compound lens can correct the astigmatism of a laser diode.

Two single-axis lenses of uniform index can also be employed for elimination of astigmatism. In addition, a symmetric two-axis lens can be employed in conjunction with a single-axis lens. Fujino et al (U.S. Pat. No. 5,216,687) employed such a design for coupling a laser diode into the end of a resonating cavity of a solid-state laser.

Astigmatism of a Lens

A lens can display astigmatism in two forms: focal length and focal position. A two-axis lens can have orthogonal focal axes with identical axial positions but different effective focal lengths. Henceforth, this is referenced as astigmatism in focal length. Also, a two-axis lens can have orthogonal focal axes with identical focal lengths but different axial positions. Henceforth, this is referenced as astigmatism in focal position. There is also an astigmatism associated with each side of the lens: the front for the incident beam, and the back for the exiting beam. Henceforth, this is referenced as the incident and exiting astigmatisms of the lens.

In total, there are four possible numeric parameters for astigmatism of the lens. The numeric value of these parameters for astigmatism can be expressed as the mathematical difference between spatial parameters applicable to the orthogonal parameters. Thus, a zero exiting astigmatism for the lens indicates equality for the orthogonal focal lengths and equality for the orthogonal focal positions on the exiting side of the lens.

Manufacture of Grin Lenses

The company Lightpath Technologies manufactures a type of graded index glass called GRADIUM®. It is fabricated by is by the bulk diffusion of stacked sheets of glass of various thickness and indexes. This bulk diffusion, achieved by heating the glass, transforms the step index profile into a smooth curve. This mature technology is well suited for the single-axis lenses of this article, especially the lens elements of weak optical power. Many lenses can be cut from a single block of GRADIUM glass.

Two-axis GRIN lenses are manufactured by at least two companies. NSG manufactures radially graded index lenses known as Selfoc lenses. Grintech also manufactures radially graded index lenses. Both of these manufactures employ ion diffusion to create a radial profile.

A single-axis graded index lens is available from Grintech. Grintech recommends this lens for collimation of the fast axis of a laser diode, which is the more rapidly diverging axis. This mature technology is also well suited for the single-axis lenses of this article. Many lenses can be cut from a single large block.

Packaging

Packaging of fiberoptic components is a rapidly growing industry. The process know as “pigtailing” refers to the integration of short length of fiber to an electro-optical package that contains sources, detectors, filters, switches, et cetera. The short length of fiber is curled like a pig's tail to relieve any mechanical stress in the connection the next length of fiber. Thus, the term pigtail applies.

Positioning technology for fiberoptic packaging is extremely mature, but fixation technology is not. The required tolerance of 0.1 um is easily achieved by today's technology. However, there are significant opportunities for major improvements in methods of fixation. Every method of fixation involves shifts that can easily exceed the demanding tolerance limits. Thus, many parts must be reworked or rejected. This reduces capacity of production as well as increases the cost of production.

Several methods of fixation are in use today. They are welding, catalytic epoxy, and optically cured adhesive.

Welding is popular because the weld can be adjusted after fixation. Actually, the thermal stress of the welding creates significant shifts. Newport employs a combination of mechanical stress and laser hammering to shift the weld clips after fixation. An undesirable requirement of this technology is the metal housings for all optical components. These metal fixtures are necessary for dissipation of heat created by the welding process. They add the cost and complexity of the assembly.

Catalytic epoxies provide strong bonds, but they also display shifts during fixation. Also, the time to cure can be significant. Parts fixed in place by catalytic epoxy cannot be reworked if the demanding tolerances are not met. They must be rejected.

Optically cured adhesives are growing in favor because of their rapid curing time. Thirty seconds of exposure to ultraviolet light can be sufficient. However, parts fixed in place by optical epoxy cannot be reworked if the demanding tolerances are not met. They must be rejected.

The optical adhesives are extremely well suited to the technology of this article because there are no air gaps in many of the packaging schemes. Furthermore, the optical adhesives can be cured within the relaxed tolerances of this new design. Therefore, shifts during fixation will not necessitate rejection. There are several vendors available for optical epoxy.

Automation is needed to meet the rapidly increasing demand for fiberoptic components assembled at reduced costs. Many of the existing assembly procedures are still ad hoc, and therefore costly and susceptible to reliability and yield problems while not being able to meet the demand for coupling-efficiency, cost, and delivery.

It is an objective of the present invention to provide an optical system amenable to automation, where computers perform the alignment.

It is another object of the present invention to better optimum delivery of energy into single mode small mode 10 um pattern. It is a related object of the present invention to provide increased coupling efficiency and reduced assembly cost of the optical couplers.

### SUMMARY OF THE INVENTION

The limitation of the prior art and the above objects and other advantages are provided by the present inventive compound lens and method of aligning a light beam therewith. The beam of light originates from a source and is coupled into a sink. The beam of light is preferably, a single-mode laser-beam of Gaussian profile from the laser diode. However, in other preferred embodiments, multimode and non-Gaussian beams not originating from a laser diode may be used to advantage. Herein a beam waist is defined as the portion of the beam with the smallest cross-section across the direction of travel by the beam. Herein a lens is specified in two forms: a one-axis lens and a two-axis lens. A one-axis lens modifies the beam along a single radial direction, which is orthogonal to radial orientation of its focal axis. A one-axis lens defines both a focal length and focal point. A focal length indicates the strength of the lens, and the focal point describes the location of the focal axis. A two-axis lens has two orthogonal focal axes with not necessarily equal focal lengths or coincident focal points. The optical power of either lens is created by a surface profile, or a refractive index profile, or both.

The present inventive compound lens includes at least two one-axis lenses that intersect and act on a light beam, herein referenced as “beam,” traveling along a single axis—an optical axis. The light beam defines a first and a second beam that are external to the inventive lens and where the first beam has an absolute convergence that is less than or equal to the absolute convergence of the second beam.

In one embodiment, the two lenses are optically coupled to each other and are arranged such that the two focal axes, defined by each one-axis lens, are not parallel to each other; preferably, these two axes are orthogonal to each other. A translation axis that herein defines a direction is established that is not parallel to either of the focal axes, preferably the translation axis bisects the angle formed by the two focal axes. Also, terms that indicate “moving along a direction” or such similar phrases are defined herein as moving back and/or forth along this direction. In this embodiment, when either of the two one-axis lenses is moved back and/or forth along the direction of the translation axis, the angular direction of the exiting beam is moved within axial planes that are normal to the respective individual axes of focus.

An advantage of the present invention is that the translation of the optical elements along a single translation direction across the optical axis allows control of one or more of the orthogonal parameters of the exiting beam. The orthogonal parameters by definition are mutually independent and mutually exclusive. The referenced orthogonal parameters of the exiting beam include: directions within orthogonal axial planes, radial is positions, radial dimensions of the beam waist, and the axial positions of orthogonal beam waists.

Astigmatism of a beam is controlled in an embodiment of the present invention.

In this instance, astigmatism of a pair of one-axis lenses indicates the numerical differences between the orthogonal focal lengths and orthogonal focal points of the two lenses. A single pair of one-axis lens elements cannot simultaneously have the first condition of coincident focal points and the second condition of equal focal lengths, therefore the range of astigmatism for this pair of lenses is not complete. A single one-axis lens may be added that complements the range of astigmatism by including the simultaneous occurrence of the aforementioned first and second conditions. This condition of zero astigmatism of the lens within a focused beam is essential for maximum delivery of a circular source into a circular sink.

In another embodiment, an optical wedge is placed to provide means for modifying the axial optical length of the inventive compound lens while maintaining a constant physical path length. Translation of the wedge along the single translation direction shifts the axial positions of the orthogonal beam-waists of an exiting beam.

An external beam is defined as external to any particular embodiment of the inventive compound lens elements. The absolute convergence specifies the absolute value of the angle of convergence of the beam, and external beams are referenced by their relative absolute convergences. Herein an external beam may be an entering or exiting beam.

A compound lens made in accordance with this invention has at least three formats. First, a collimating lens transforms a diverging beam into a nearly collimated beam. Second, a focusing lens transforms a nearly collimated beam into a convergent beam. And, third, a relay lens transforms a divergent beam into a convergent beam for relay of light from a source to a fiber.

In one embodiment, a relay lens includes a combination of two compound lenses where the exiting beam of one compound lens is the entering beam of the other compound lens. In this instance, the two coincident external beams should have near zero absolute convergences.

The present invention provides for a group of optical elements that are arranged in a base configuration to intersect a beam of light that defines a first and a second beam that are both external to the inventive compound lens. The first beam has an absolute convergence that is less than or equal to the second beam. In general, preferred embodiments of the present invention include the base configuration with combinations of additional optical elements added to the base configuration. One such base configuration includes two one-axis lenses where the focal axis of each are non-parallel, and means to move each lens in a translation direction that is non-parallel with either focal axis. To this base configuration an optical wedge is added to the more convergent second external beam such that when the optical wedge is moved in the translation direction the axial positions of the exiting orthogonal beam waists are adjusted. In addition, another wedge may be placed between the first and second one-axis lenses which when moved along the translation direction will predominantly adjust the axial position of only one exiting orthogonal beam waist.

In another embodiment of the first base configuration, a third and fourth one-axis lenses are added intersecting the first or the second beam with respect to the base configuration above. In one preferred embodiment, the third and fourth lenses have focal lengths of about forty times that of the first and second one-axis lenses.

In still other embodiments of the first base configuration a fifth lens, a defocusing optical element, may be added to intersect the second beam, and/or a sixth one-axis lens may be added to intersect either the first or the second beams to compensate for astigmatism.

In a preferred embodiment, that includes the fifth and the sixth lenses, a pair of one-axis lenses, similar to the first and second lenses, may be added to intersect the first beam, which is incident upon the base configuration. These lenses when moved along the translation axis, adjust the radial directions of the exiting beam and consequently the radial position of the exiting beam at finite distances of propagation.

In accordance with the present invention and the above referenced first base configuration, the third, fourth, fifth, and sixth lenses, and the first and second wedges may be used in any combination and any permutation with the first base configuration. Here “combination” is defined as any grouping or sub-grouping of any of the lenses. Permutation refers to a combination with specific order of the placement of the lenses.

A second base configuration is comprised of a two-axis lens and a first and a second one-axis lenses; all intersecting the beam. This base configuration intersects a laser beam and consequently defines a first and second external beams. In a preferred embodiment derived from this second base configuration, the focal lengths of the first and second one-axes lenses are about 40 times that of the two-axis lens. In another preferred embodiment, a wedge is added to the more convergent second external beam for control of the axial position of the exiting beam waist. In another embodiment, a third one-axis lens is added to either external beam of the second configuration for control of the spread of the exiting beam across the focal axis of the third one-axis lens. The wedge and the third one-axis lenses may be used in any combination and any permutation with the second base configuration.

An embodiment of the present invention includes that of a relay lens. Such a relay lens is a pair of inventive assemblies made from any permutation of lenses described in the preceding paragraph. In such an instance, the pairs are arranged optically coupled to each other wherein the first beam for one lens assembly is the first beam for the second lens assembly. Such a relay lens can be used advantageously to direct a light beam exiting an optical source, such as a diode laser or a fiber, to a receiving optical sink, such as a fiber, a flow cell or an light (or energy) detector. In the case of a detector or a flow cell the preferred embodiment application would be in a scientific or other such measuring device or instrument.

The optical elements of the first and second compound lenses of a relay lens are each dedicated to adjustment of single orthogonal parameter of the beam at the sink. As examples, two one-axis lenses of a first compound lens are dedicated to the angular directions of the beam entering a sink, while two one-axis lenses of the second compound lens are dedicated to the radial positions of the beam at the sink. In another configuration, the a wedge of the first compound lens controls the diameter of the beam at the sink, while a wedge of the second compound lens controls the axial position of the beam waist at the sink. In a similar application, a wedge of the first compound lens controls the dimension of only one radial axis of the beam at the sink; and a wedge of the second compound lens controls the axial position of only one radial axis of the beam at the sink. Insertion of an axial spacer between the first and second compound lenses reduces the effects of the first compound lens upon the parameters specified for control by the second compound lens.

Specific forms of one-axis lenses are claimed. In a preferred embodiment, a one-axis lens has a flat planar radial surface and flat planar axial surface; the intersection of these planar surfaces defines the axis of travel for the one-axis lens. In another embodiment, the one-axis lens is a graded index lens with a second radial flat planar surface to which similar elements are optically joined with essentially no reflections at the interface.

### BRIEF DESCRIPTION OF THE DRAWINGS

The invention description below refers to the accompanying drawings, of which:

FIG. 1A, 1B, and 1C are line/ray drawings that display a Gaussian-beam wavefront in several situations;

FIG. 2 is a line/ray drawing of prior art for beam delivery with six degrees of freedom (DOF);

FIG. 3 is a line/ray drawing that describes optical leverage;

FIGS. 4A, 4B, and 4C are line/ray drawings that display the control of three orthogonal DOFs by orthogonal translations;

FIGS. 5A and 5B are a perspective line/ray drawing and an end view displaying the control of three orthogonal DOFs by translation along a single-axis;

FIGS. 6A and 6B are the end views of two lenses with apertures that are parallel to the axis of travel;

FIGS. 7A, and 7B are line/ray drawings displaying an astigmatic graded-index collimating lens;

FIGS. 8A, and 8B are representations of index of refraction profiles of a single-axis graded-index lens;

FIGS. 9A, and 9B are isometric views of several types of graded-index lenses cut from the same block;

FIGS. 10A, 10B and 10C are exploded isometric views of a first, second and third configurations of compound lenses formed by one-axis graded-index lenses;

FIG. 11 is an exploded isometric view of a fourth configuration of a lens;

FIG. 12 is an exploded isometric view of a fifth configuration of a lens;

FIG. 13 is an exploded isometric view of a sixth configuration of a lens;

FIGS. 14A, 14B, and 14C are exploded isometric views of a seventh, eighth, and ninth configurations, respectively, of a lens;

FIG. 15 is an exploded isometric view of a first configuration of fiber-to-fiber;

FIG. 16 is an exploded isometric view of a tenth configuration of a lens;

FIG. 17 is an exploded isometric view of a first configuration of a diode-to-fiber coupler;

FIG. 18 is an isometric view of an assembly of a diode-to-fiber coupler;

FIGS. 19A-F are views of an assembly of a diode-to-fiber coupler;

FIGS. 20A-F are views of an assembly of minimum configuration of a diode-to-fiber coupler.

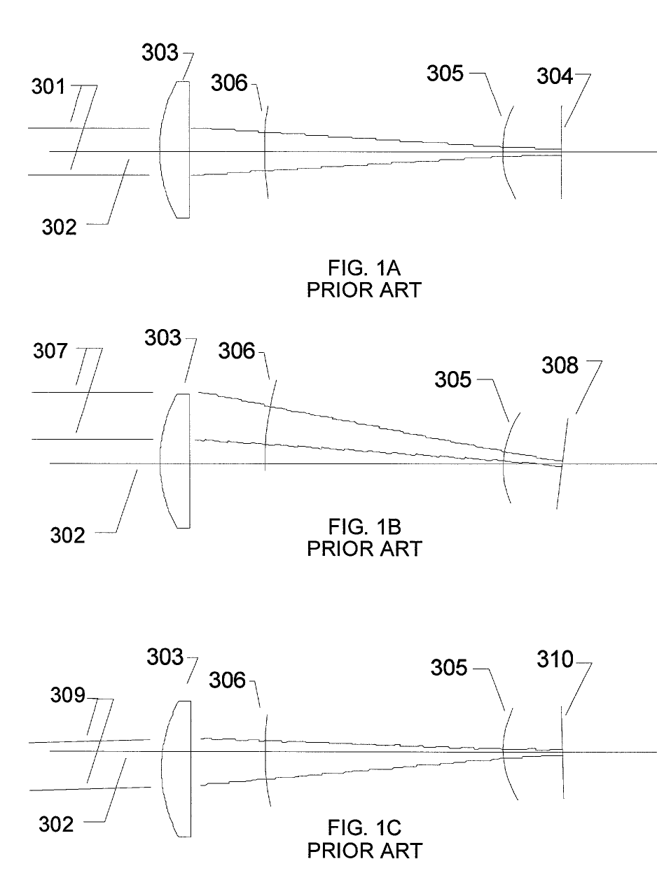

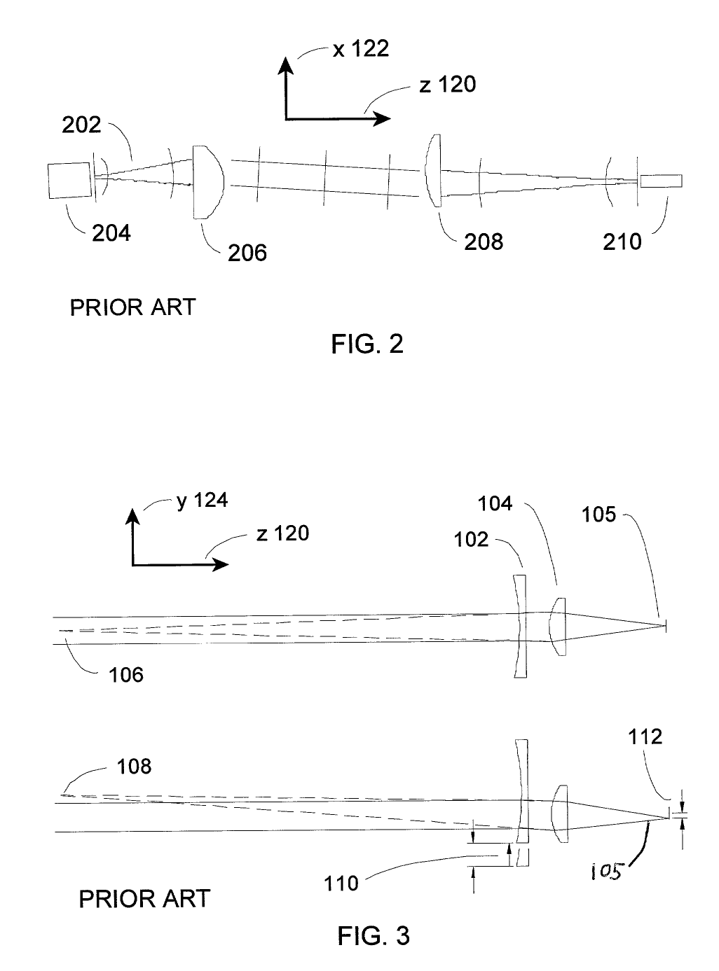

### DETAILED DESCRIPTION OF ILLUSTRATIVE EMBODIMENTS

Orthogonal Translation Along 3 Axes

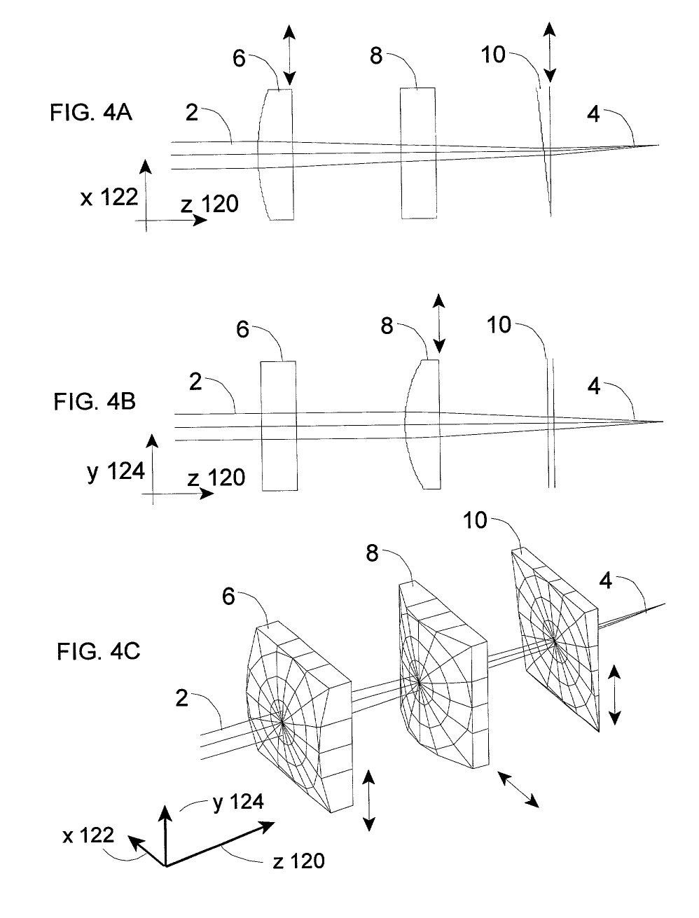

FIG. 4A shows an optical arrangement where the propagating beam has two forms on either side of the compound lens. They are distinguished by their absolute convergence. A nearly collimated beam 2 of near zero absolute convergence can be either entering or exiting the lens. A convergent beam 4 can be either exiting the lens as converging beam or entering the lens as a diverging beam. For the sake of simplicity, in this article, the nearly collimated beam 2 will be referred to as the less convergent beam, and the converging or diverging beam 4 will be referred to as the more convergent beam.

In the preferred embodiment of FISG. 4A, 4B, and 4C, two single-axis lenses 6 and 8 are translated along orthogonal axes. FIG. 4A displays the view of the y-z-plane. FIG. 4B displays the view of the x-z-plane. FIG. 4C displays an isometric view. The first lens 6 is a single-axis lens with its focal axis aligned to the x-axis 124. Translation of the lens along the y-axis 124 also deflects the converging beam along the y-axis. The second lens 8 is a single-axis lens with its focal axis aligned to the y-axis. Translation of the lens along the x-axis 124 also deflects the converging beam along the x-axis. The wedge 10 is placed within the more convergent beam 4. This must be so because the wedge has practically no effect upon a nearly collimated beam. Translation of the wedge along the y-axis translates the beam waist along the z-axis.

There are three DOFs and two orthogonal axes of translation in this design. Two of these DOFs are the pitch and yaw of the exiting beam. The third DOF is the axial position of the exiting waist. The two orthogonal axes of translation are aligned to the focal lines of the two single-axis lens elements.

Conversion to Single Axis of Translation

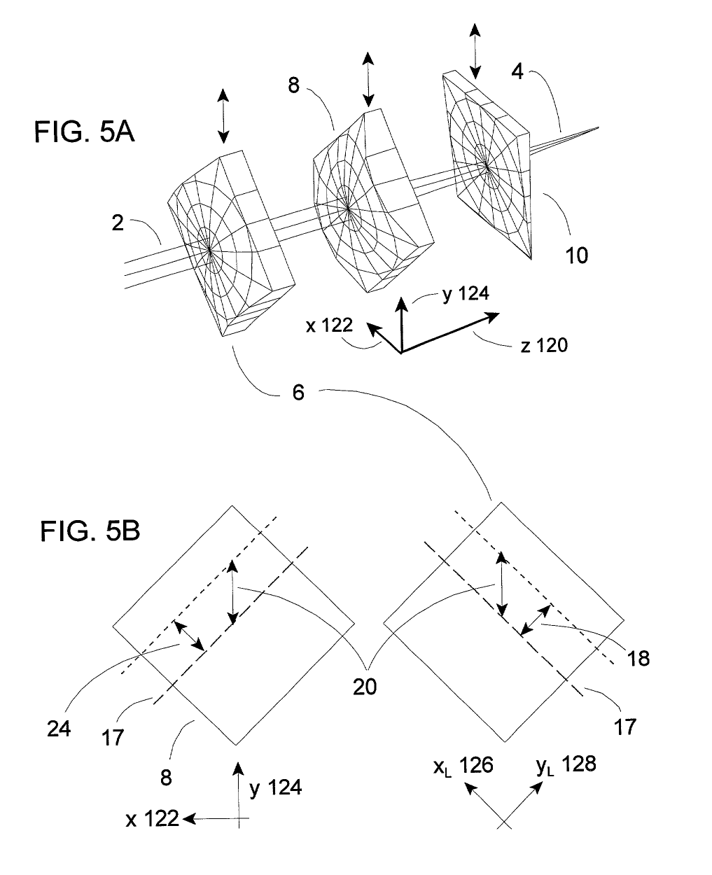

The two single-axis lenses can be translated along the same axis as shown in FIGS. 5A and 5B. In FIG. 5A, the crossed single-axis lenses are rotated by 45 degrees with respect the x- and y-axes. The end views of these lenses are presented in FIG. 5B. A second coordinate system is defined for the lenses. The lens x-axis 126 and the lens y-axis 128 are displayed in FIG. 5B. The z-axis of the lens is still the optical axis.

The position of the incoming beam relative to the focal line 17 of either lens determines the angular displacement of the exiting beam. Two paths of translation by the lens 6 are shown as 18 and 20. These paths of translation determine the position of the incident beam on the lens. The beam position on the lens moves in the opposite direction of the actual motion by the lens. Movement of the beam position on the lens 6 along either path 18 or 20 will have identical effects upon the exiting beam—an exiting beam will deflect along the lens y-axis 128. Similarly, two paths of translation by the y-rotated lens 8 are shown as 24 and 20. Movement of the beam position on the lens along either path 24 or 20 will have identical effects upon the beam at the fiber—the exiting beam will deflect along the lens x-axis 126. Clearly there are numerous options for translation by the two lenses.

One particular pair of motions by the two single-axis lenses is discussed below with reference to the prior “complete set of vectors.” This special pair is created by motion of both lenses along path 20 in the radial plane. This condition creates independent orthogonal deflections of the exiting beam while employing only one axis of translation. The conditions of both orthogonal and independent motions are achieved by orthogonal orientation of focal lines of the two lenses. The condition of equal leverages is achieved by locating the axis of translation along the bisecting line of the angle between the two focal lines of the cylindrical lenses. This bisecting line is the y-axis 124.

The radial translation of a rotated single-axis lens creates a smaller effective radial translation across its focal axis. This reduction factor is the cosine of the angle between the actual path of translation 20 and the effective path 18 or 24.

Aperture of Rotated Single-Axis Lens

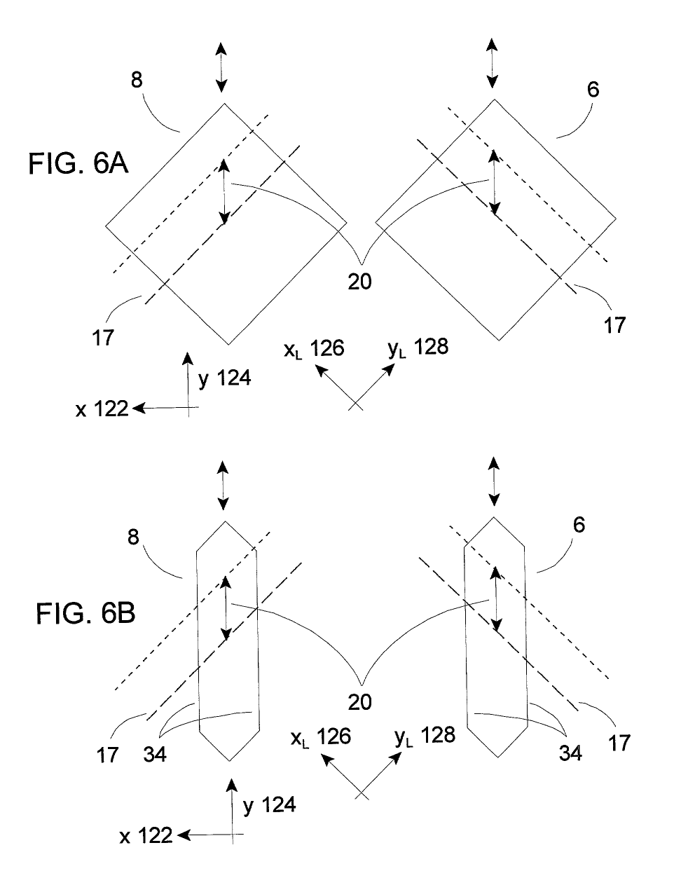

The aperture of a single-axis lens should be aligned to axis of translation. FIG. 6A displays the pair of single-axis lens elements. In FIG. 6B, the apertures of both lenses 6 8 have edges 34 that are parallel to the translation axis 20. These edges can be used as guide for the translating lens. A combination of these edges and the optical axis forms a plane that is suitable for alignment of the lens.

Single-Axis GRIN Lenses

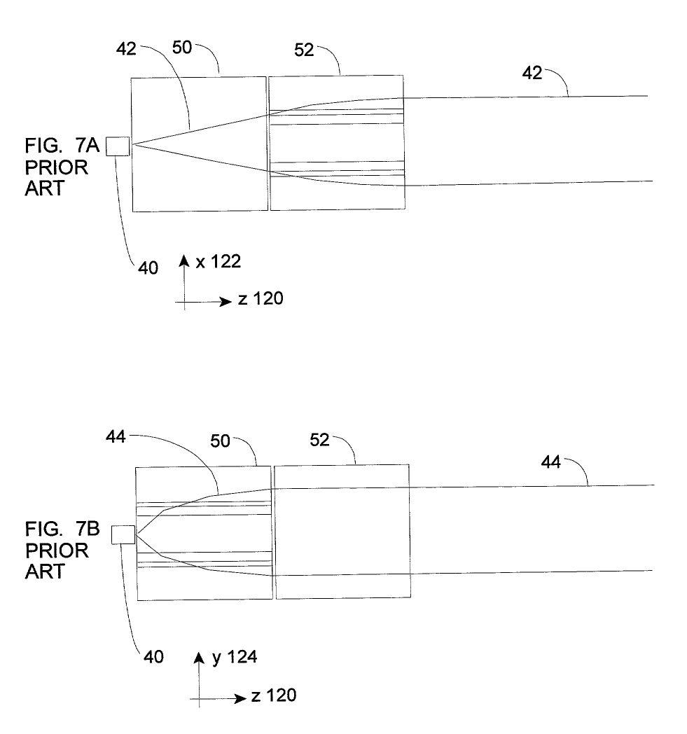

A single-axis grin lens is a preferred form of many lens elements in the embodiments of the invention. The effects of an astigmatic collimating lens are shown in FIGS. 7A and 7B.

FIGS. 7A and 7B show the laser diode 40 that emits a beam with asymmetric divergence. This asymmetric divergence creates two very different profiles. In FIG. 7A, the slow-axis divergence 42 occurs along the x-axis 122. In FIG. 7B, the fast-axis divergence 44 occurs along the y-axis 124. The compound lens corrects for this astigmatism by implementation of two orthogonal graded-index single-axis lenses 50 and 52. The orthogonal radial components of the electric field of a Gaussian beam profile are separable as product of two orthogonal functions of the x- and y-axes. Consequently, the spatial dependency of the beam upon x can be modified without impacting the spatial dependency upon y, and vice versa. This permits independent modifications of the orthogonal components of the beam profile by the two single-axis lens elements.

The first single-axis lens 50 is for collimation in the y-axis. The second single-axis lens 52 is for collimation in the x-axis. The graded index of the first lens 50 is designed to collimate the beam to a specific value. Subsequently, the beam passes though the second cylindrical lens 52 without any modification to the y-profile.

The graded index of the second single-axis lens 52 is designed to collimate the beam to the same value as done by the first lens 50. The second lens must compensate for the effects of the first, which functions as a spacer block of uniform index along the x-axis. Accommodation of this spacer by the second lens 52 is a simple task.

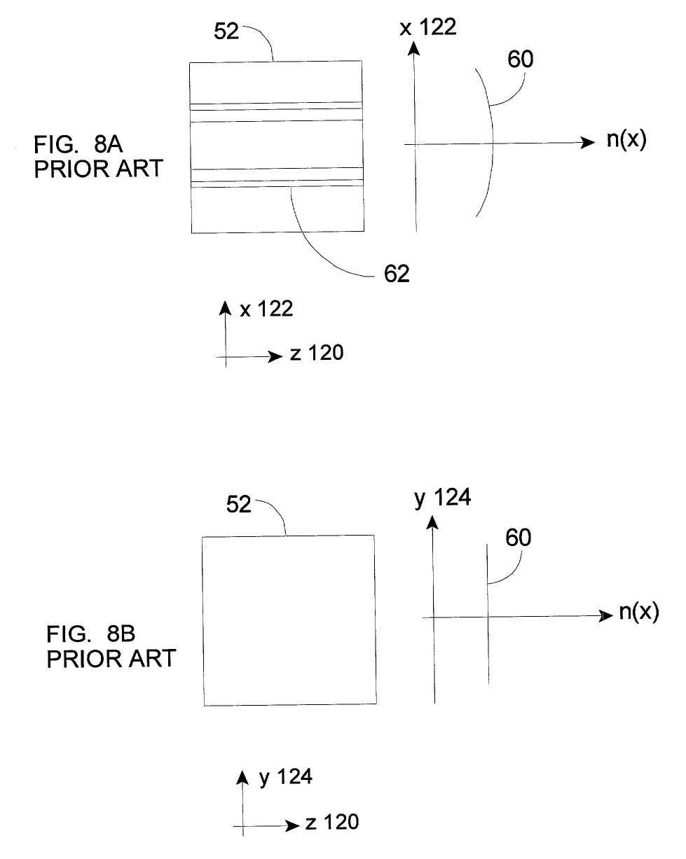

The index profile 60 of the second graded-index single-axis lens 52 is displayed in FIG. 8A and FIG. 8B. In FIG. 8A, the index profile 60 along the x-axis resembles an arc. In FIG. 8B, the index profile 60 along the y-axis is uniform. The profile along the x-axis is equivalent to the radial index profile of present-day graded-index lens. In FIG. 8A and subsequent figures, topographical lines 62 represent the index profile. In FIG. 8B and subsequent figures, the absence of topographical lines indicates a uniform index for that perspective.

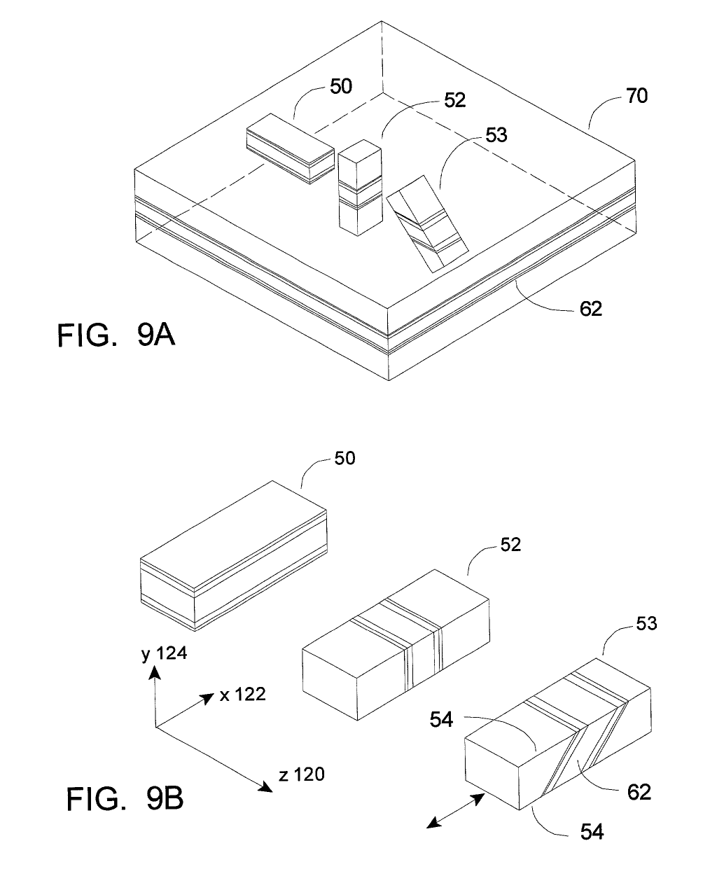

The index profile of the single-axis lens is created by one of the previously cited methods. A single slab of graded index material 70 is displayed in FIG. 9A. The topographical lines of the index profile 62 are displayed. This slab 70 can be cut into many types of cylindrical lenses 50, 52 and 53. FIG. 9B illustrates their faces aligned to the axes of the coordinate system 120, 122, and 124. The first two lenses 50 and 52 can be used for the previously discussed astigmatic collimating lens. The third lens 53 is well suited for a single-axis translation of the present invention.

This third lens 53 is referred to as a rotated single-axis lens. Its focal axis is at an angle with respect to its surface profile. Its surface profile defines the most logical axis of translation as along the x-axis. Specifically, the edges 54 of the apertures define appropriate translation vectors a combination of one these of these edges and the optical axis along the z-axis 126 forms an appropriate plane on which the lens can translate but also mount in place by fixation with adhesive . A pair of these rotated single-axis lenses 53 can be used to achieve orthogonal deflections of the beam with a single axis of radial translation. A description thereof proceeds. They both translate along a single axis which should be parallel an edge of the apertures.

Single-Axis Translation of Two Single-Axis Grin Lenses

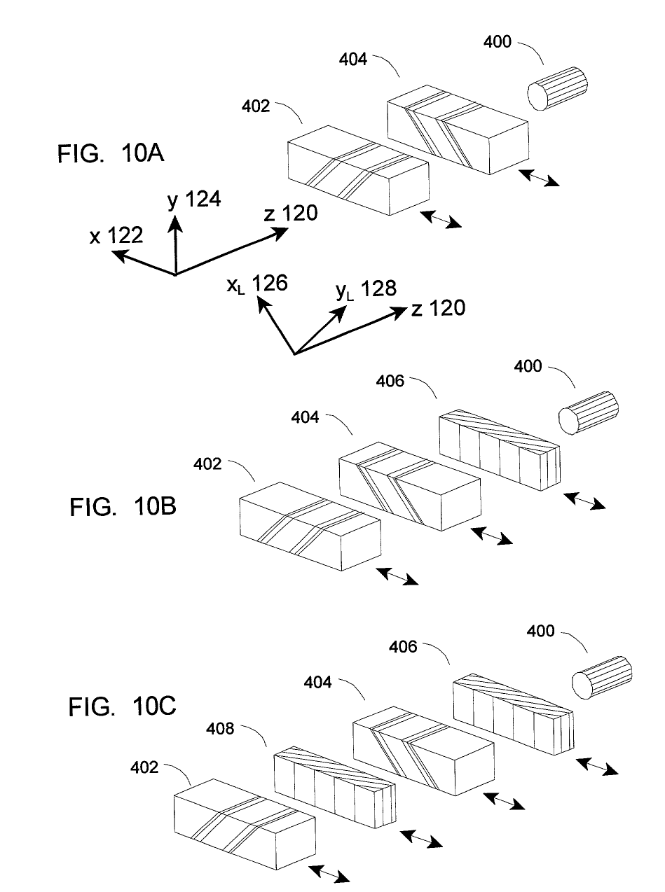

FIGS. 10A, 10B, and 10C show a build up of configuration of optical devices that embody the present invention. Each device achieves orthogonal parameter adjustments with a single axis of translation. Each device has several actions along this single axis of translation. These actions create several degrees of freedom (DOFs) in the parameter space.

FIG. 10A displays a first configuration of a compound lens with two DOFs. Two rotated single-axis lenses 402, 404 are employed to manage a converging beam at a fiber 400. This converging beam can either be a focused beam incident upon the fiber or a diverging beam exiting the fiber. The first single-axis lens 402 has its focal axis aligned to lens y-axis 128. The second single-axis lens 404 has its focal axis aligned to the lens x-axis 126. Both lenses translate along the x-axis of the world coordinate system 122. Translation of the first lens 402 deflects an exiting beam across it focal axis, which is along the lens x-axis 126. Translation of the second lens 404 deflects an exiting beam across it focal axis, which is along the lens y-axis 128. If the more convergent beam is incident upon the fiber, then translation of the first lens controls the position of the beam at the fiber along the x-axis of the lens, and the second lens controls the position of beam at the fiber along y-axis of the lens. If the more convergent beam is exiting the fiber, then translation of the first lens controls the yaw of the exiting beam along the x-axis of the lens, and the second lens controls the pitch of the exiting beam along y-axis of the lens. This first configuration has two DOFs created by two independent actions.

In FIG. 10B, a first wedge 406 is added to the first configuration of FIG. 10A within the more convergent beam. Translation of this first wedge adjusts the axial optical path length within the converging beam while maintaining a constant physical axial path length. If the more convergent beam is incident upon the fiber, then the translation of the first wedge adjusts the axial position of the beam waist along both lens axes 126 128. If the more convergent beam is exiting the fiber, then translation of the first wedge controls the divergence of the exiting beam along both lens axes 126 128. This second configuration has three DOFs created by three independent actions.

FIG. 10C shows a third configuration with a second wedge 408 added, to the second configuration of FIG. 10B, between the first and second lenses. Translation of this second wedge adjusts the axial optical path length within the beam while maintaining a constant physical axial path length. If the more convergent beam is incident upon the fiber, then the translation of the second wedge adjusts the axial position of the beam waist across the focal axis of only the first lens. If the more convergent beam is exiting the fiber, then translation of the second wedge controls the divergence of the exiting beam across the focal axis of only the first lens. This third configuration has four DOFs created by four actions. The two actions of the wedges are not orthogonal because each contains a significant potion of the other. However, they do form a complete set, and they are sufficiently different from each other for practical application.

Incorporate Two Weak Lenses

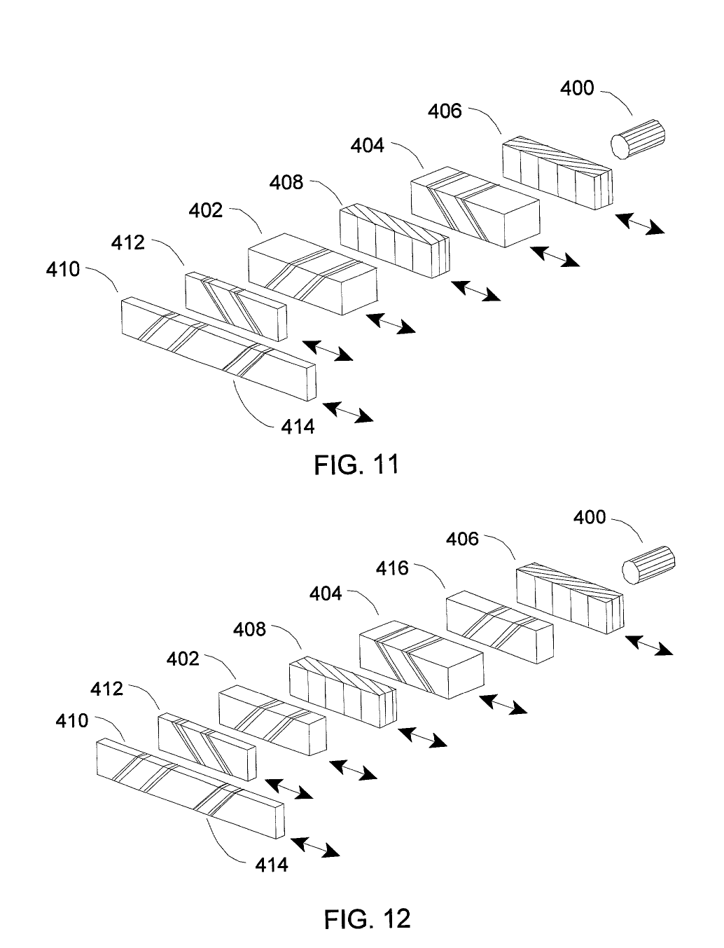

FIG. 11 shows a fourth configuration with third and fourth single-axis lenses 410 and 412 that provide fine control of the exiting beam. The third lens 410 acts in the same manner as the first lens 402. The fourth lens 412 acts in the same manner as the second lens 404. These third and fourth lenses have much longer focal lengths than the first and second lenses. Consequently, their effects upon the beam are much weaker. These weak lenses are typically added to the external beam with the smaller absolute convergence. The effect of each lens is in proportion to its optical power, which is the reciprocal of the focal length. This proportional effect was previously described as optical leveraging. This fourth configuration has four DOFs created by six independent actions. These two additional actions provide fine adjustment of pitch and yaw of the exiting beam which is also fine adjustment of the radial position of the exiting waist..

This optical leverage greatly relaxes the assembly tolerances. A converging beam incident upon the fiber must be aligned within 0.1 um with the radial plane. Maintaining this accuracy for the beam at the fiber is greatly facilitated by the optical leverage of the third and fourth lenses. If the third and fourth lenses are 40 times greater in focal lengths than the focal lengths of the first and second lenses, then the optical leverage is 40. Consequently, a much larger tolerance of 4 um of accuracy is achieved at the third and fourth lenses for maintaining 0.1 um of accuracy for the beam incident upon the fiber.

The third lens 410 also includes a fifth lens 414 for defocusing the beam across the focal axis of the third lens. This fifth lens 414 spreads a beam incident upon the fiber across the focal axis of the third lens. The resulting elliptical spot can be easily directed into the fiber by translating the beam across the long axis of this ellipse. This one-dimensional search is much easier that the two-dimensional search required for a spot focused along both axes at the fiber. It facilitates finding the beam at the beginning of an alignment procedure.

Conversion to Corrected Lens

In FIG. 12, a sixth lens 416 corrects the astigmatism of the fourth configuration for the converging beam. In such a corrected format, the combination of the first, third, and sixth lenses creates the same focal point and same focal length within the more convergent beam as the combination of the second and fourth lenses. These orthogonal lens combinations are axially equivalent within the more convergent beam. Thus, when an incident beam is both round in profile and flat in wavefront, the exiting beam has no astigmatism. However, the orthogonal lens combinations are not equivalent within the incident beam, because the orthogonal focal axes are not coincident. Fortunately, this inequality has little effect upon a nearly collimated beam. This fifth configuration complements the range of astigmatism of the previous configurations. This fifth configuration has four DOFs created by six independent actions with two redundant actions for fine adjustment of the exiting beam angle along the two axes of the lenses.

Free Space Coupler

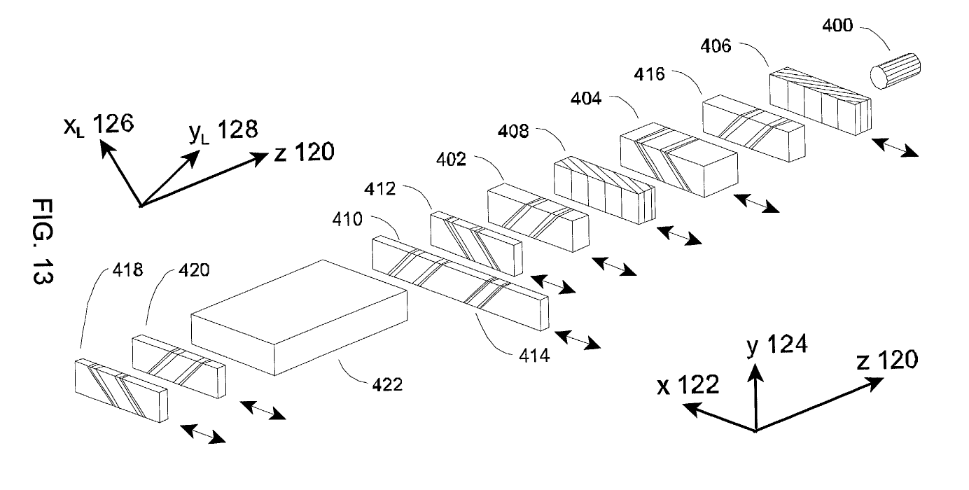

In FIG. 13 a seventh 418 and an eighth 420 lenses are added to fifth configuration to control the radial position of an incident beam within the fifth configuration. This sixth configuration is the first configuration of a free-space laser coupler. It is applicable to coupling a free-space laser-beam into an optical fiber. The radial position of the incident beam at the entrance of the fifth configuration is converted by the fifth configuration into the angle of the wavefront normal at the fiber. Thus, translations of the seventh lens 418 along the x-axis 122 control the pitch of the wavefront along the lens y-axis 128. Translation of the eighth lens 420 along the x-axis 122 controls the yaw of the wavefront along the lens x-axis 126. This fifth configuration has 8 DOFs with 10 single-axis translations all along the same direction. The effects of each translation are listed below as they apply to an incident collimated beam focused upon a fiber.

| | Items as encountered | |
|---|---|---|
| | by incident | Parameter at first fiber affected |
| Tag | collimated beam | by translation of item |
| 418 | Pitch lens | Pitch of wavefront along y-lens |
| 420 | Yaw lens | Yaw of wavefront along x-lens |
| 422 | Pitch-yaw spacer | — |
| 410 | Fine x-lens | Fine x-lens position of beam |
| 412 | Fine y-lens | Fine y-lens position of beam |
| 402 | Coarse x-lens | Coarse x-lens position of beam |
| 408 | y-lens wedge | Axial position of y-lens axis of waist |
| 404 | Coarse y-lens | Coarse x-lens position of beam |
| 416 | Corrective lens | — |
| 406 | x-y wedge | Axial position of both axes beam waist |
| 400 | Fiber | — |

Still referring to FIG. 13, translations of the seventh and eighth lenses also affect the exit angle of the converging beam. Consequently, translations of the sixth and several lenses affect the position of the beam at the fiber along the x- and y-axes of the lens 126 128. These effects are reduced by increasing the separation of the pitch-yaw elements 418 and 420 from the x-y elements 402, 404, 410, and 412.

The redundancy of the pitch-yaw and x-y elements is determined by their separation, which is filled with a spacer block 422. At zero separation the pitch-yaw elements are practically redundant with the x-y elements. As the spacer block grows in length, the redundant effects are reduced. At very long lengths, translations of the pitch-yaw elements have essentially no effect upon radial position of the beam at the fiber, and these translations affect pitch-yaw at the fiber.

In theory, any finite separation of the pitch-yaw and x-y elements is sufficient for a complete set of vectors, which control the pitch-yaw and x-y of the beam at the fiber. Such a complete set is not orthogonal, but it is sufficient for complete control of the orthogonal space parameters of the beam at the fiber. In practice, a sufficiently large spacing is determined by the specifics of each design.

Separation of the pitch-yaw elements from the x-y elements determines the number of required iterations of alternating adjustments of pitch-yaw and x-y. However, an increased length consumes valuable space. Therefore, the axial length of the pitch-yaw spacer block 422 is very subjective. As a starting point, its length should be one to two times the immersion focal length of the stronger focusing elements.

The x-y elements also affect the pitch-yaw of the beam at the fiber but not significantly in comparison to the radial position. As an example, a 10-um waist formed by an x-y element of 1-mm focal length lens subtends an angle of 10 mrad with respect to that x-y element. A 1-um shift creates a 1 -mrad tilt of the wavefront. The effect upon coupling efficiency by a 1-um shift is much greater than the effect of the corresponding 1-mrad tilt. Therefore, the effect of the x-y element is predominantly expressed by the radial position of the beam-waist at the fiber.

Hybrid Lenses

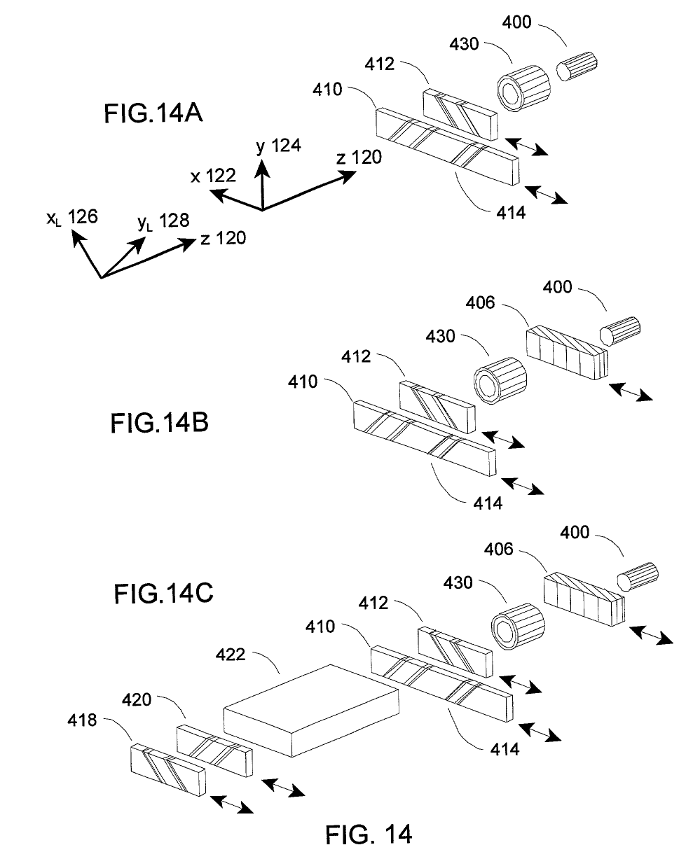

A first two-axis lens can be used in place of the first, second, sixth lens elements. Configurations with a first two-axis lens 430 are shown in FIG. 14. In FIGS. 14A, 14B, and 14C, the seventh, eighth, and ninth configurations are shown. The two-axis lens 430 is represented as a radially graded index lens.

FIG. 14A displays the seventh configuration. The fourth 410, fifth 412, and sixth 414 lens elements are placed within the less convergent beam. Their functions are the same as previously described. The fourth and fifth lens elements deflect the exiting beam across their respective focal axes. The sixth element defocused the beam along a single axis for ease alignment of the other axis. This seventh configuration has two DOFs created by two independent single-axis translations.

FIG. 14B displays the eighth configuration in which the first wedge 406 is placed within the more convergent beam of the seventh configuration. The first wedge performs the same as other applications of the first wedge. It controls the axial position of the exiting beam waist. This eighth configuration has three DOFs created by three independent single-axis translations.

FIG. 14C displays the ninth configuration. The seventh-and-eighth lenses 418 420 elements and the spacer block 420 are added to an incident less convergent beam of the eighth configuration. As in the sixth configuration, the seventh and eighth lens elements control the pitch-and-yaw at the fiber. This ninth configuration has five DOFs created by five independent single-axis translations

The two-axis lens is mounted in place by a fixture with a specific tolerance. The two-axis lens should be aligned to fiber axis within 1% of its focal length. This corresponds to a 20 um radial tolerance for a 2 mm focal length, which is a common focal length for present-day radially graded-index lenses. Such an assembly tolerance is reasonable.

Design and fabrication of the third, fourth, seventh, and eighth single-axis lens elements 410, 412, 418, and 420 is relatively simple because these lens elements are weak in optical power when compared the stronger first, second, and sixth lens elements. Thus, these hybrid configurations are closer to production than the purely single-axis configurations.

The eighth configuration in FIG. 14A has only two moving parts. The two-axis grin lens 430 can be aligned axially within its fixture for best positioning the converging beam's waist on the fiber's face. This seventh configuration can be employed for coupling a collimated beam into the fiber or collimation of a beam exiting the fiber. Standard connectors such as SMA and FC can be employed for kinematically mounting the fiber. After installation of a fiber, the third and fourth lens elements 410 and 412 are employed to optimize either the radial position of a beam incident upon the fiber or the angle of a collimated beam exiting the lens. The defocusing element 414 can be employed to facilitate delivery of the beam into the fiber by adjustment of the beam position along a single axis of the lens. This seventh configuration has 2 DOFs and 2 actions.

The eighth configuration in FIG. 14B has three moving parts. The first translating wedge 406 is employed to either axially shift the beam waist of the converging beam onto the fiber or manage the divergence of an exiting collimated beam. The other parts function in the same manner as the previous configuration. This configuration has 3 DOFs and 3 actions.

The ninth configuration in FIG. 14C has five moving parts. It is the second configuration of free-space coupler. There is no corrective lens because the astigmatism created the weak translating lenses is not significant. These translating elements function as they do in the first configuration of a free-space laser coupler. The seventh and eighth lens elements 418 and 420 manage the pitch and yaw of the converging beam entering the fiber. The third and fourth lens elements 410 and 412 manage the x-y position of the beam entering the fiber. The first wedge 406 manages the axial position of the beam waist at the fiber. This ninth configuration has 5 DOFs and five actions.

These hybrid configurations operate in the same manner as the corresponding purely single-axis configurations except for two important distinctions. The first distinction is the absence of coarse control by the first and second lens elements. This absent dynamic places significant assembly tolerances upon the two-axis lens. The second distinction is the absence of any dynamic corrections for astigmatism. A two-axis lens can be made with a fixed astigmatism, but there is no means for dynamic adjustment of astigmatism in these hybrid configurations.

Fiber-To-Fiber Coupler

A perfect application for these hybrid configurations is the coupling of light from fiber to fiber. In such fiber-to-fiber coupling, there is no astigmatism to correct. The mode field diameter of one fiber might differ from the other, but both mode field patterns should be circular in radial profile. Thus, some management of beam diameter is possibly required, but correction of astigmatism is certainly not.

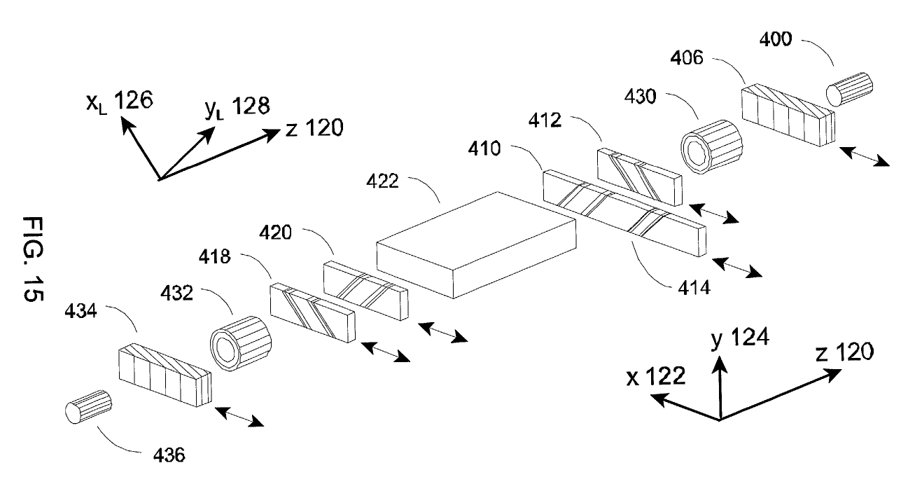

The first configuration of a fiber-to-fiber coupler is shown in FIG. 15. It resembles a symmetric combination of two of the eighth configurations. Note the mirror symmetry of the single-axis lens elements. The weak lenses 410 and 420 immediately on either side of the spacer have parallel axes. This arrangement minimizes the astigmatism associated with the axial offset of the orthogonal weak lenses. Specifically, this first configuration of a fiber-to-fiber coupler is the second configuration of free-space coupler with an addition of three elements: a second two-axis lens 432, a second translating wedge 434, and second fiber 436. If the beam travels from left to right (from the second fiber 436 to the first fiber 400), then the functions of each element are defined in the following table in the order by which the traveling beam encounters the items.

The second translating wedge 434 controls the diameter of the focused beam at the first fiber by management of the divergence of the collimated within the pitch-yaw spacer block 422. This divergence controls the diameter of the beam at the focusing elements. This diameter at the focusing elements determines the waist diameter of the focused beam incident upon the first fiber. Thus, the second wedge controls the diameter of the focused beam incident upon the first fiber.

| | Items as encountered | Parameter at first fiber affected |
|---|---|---|
| Tag | by traveling beam | by translation of item |
| 436 | Source fiber | — |
| 434 | Diameter wedge | Diameter of beam |
| 432 | Collimating two-axis lens | — |
| 418 | Pitch lens | Pitch of wavefront along y-lens |
| 420 | Yaw lens | Yaw of wavefront along x-lens |
| 422 | Pitch-yaw spacer | — |
| 410 | Fine x-lens | x-lens position of beam |
| 412 | Fine y-lens | y-lens position of beam |
| 430 | Focusing two-axis lens | — |
| 406 | Axial wedge | Axial position of both beam waists |
| 400 | Sink fiber | — |

This first configuration of fiber-to-fiber coupler has six DOFs and six actions. The six DOFs are sufficient for optimum coupling of circular mode fields with unequal diameters. It is possible to align this by hand without an automated search algorithm. It can be used to advantage in switching networks in which the collimated beam switched into different fibers.

Other fiber-to-fiber couplers are herein referenced as relay lenses which are formed by any symmetric combination of the aforementioned compound lenses. The purely single-axis configurations do create an elliptical profile in the collimated beam but this is not a problem if the two halves of the fiber-to-fiber coupler have mirror symmetry. Fibers of greatly dissimilar diameters can even be coupled by an asymmetrical combination. A multitude of combinations of the aforementioned configurations is possible.

Diode-To-Fiber Pigtailing

An important application of the device is pigtailing of a singlemode fiber to a diode laser, previously described in Packaging. Optimum delivery of the beam requires 8 degrees of freedom at the fiber. In terms of the fast and slow axes of a laser diode these DOFs are: radial position along the fast and slow axes, pitch and yaw of the wavefront, waist dimensions along the fast and slow axes, and axial positions of the fast and slow waists. Coarse adjustment of these parameters requires 8 active elements. Two additional elements are required for the fine adjustment of the radial positions along the fast and slow axes. Two additional elements can be added for the fine adjustment of the pitch and yaw but this is not required. The optimum configuration has 8 DOFs with 2 redundant actions for fine adjust of the radial positions along the fast and slow axes. Such a design has 8 DOFs with 10 active elements.

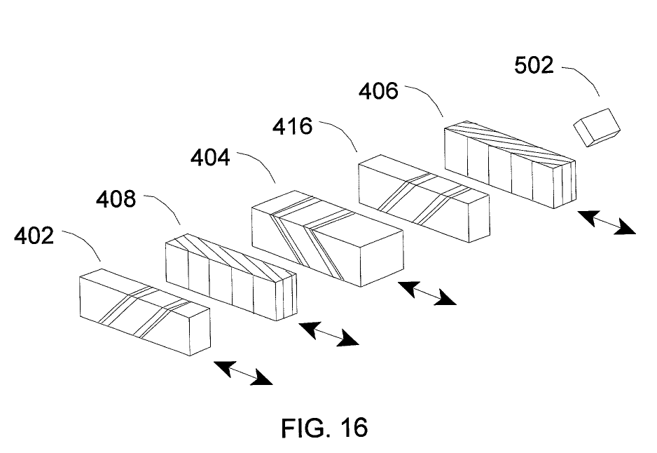

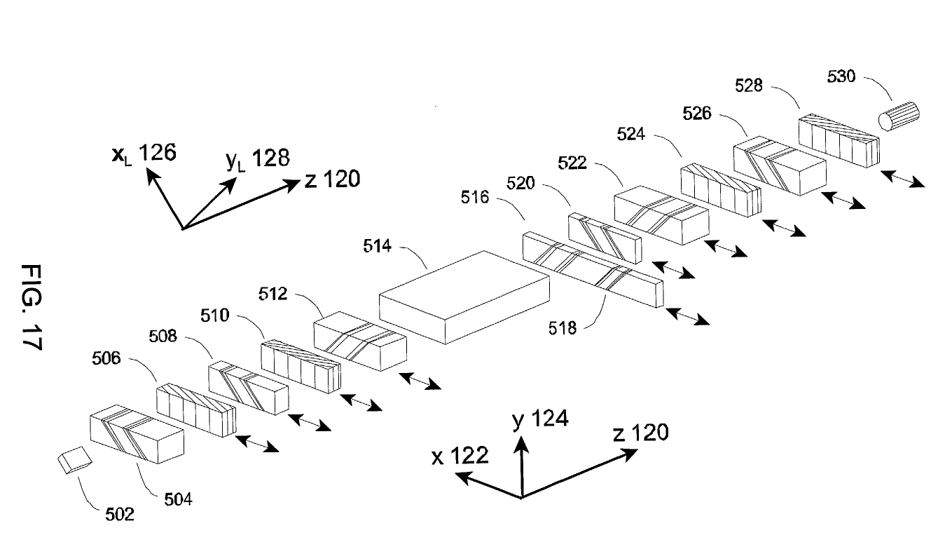

In FIG. 16, a tenth configuration is shown that is optimum for collimation of laser diode 502. It is a third configuration with the sixth lens 416 added to the converging beam. The sixth lens permits a full range of astigmatism. Thus, the astigmatism of an exiting collimated beam can be matched to any requirement. It can be placed anywhere between the second lens 404 and diode laser 502. FIG. 17 displays the preferred embodiment of the pigtailer. It is a combination of the tenth configuration and the fourth configuration. The elements are described in this first configuration of a diode-to-fiber coupler with names that are specific to the fast and slow axes of the diode. Their effects upon parameters are referenced to the fast and slow axes. The fast and slow axes correspond to the lens y-axis 128 and the lens x-axis 126 respectively. The optical system contains only single-axis GRIN lenses, wedges, and spacers. The actions performed by each element are described in table below. The double arrows display the motion of the active elements.

| | Item as encountered | Parameter at fiber affected by |
|---|---|---|
| Tag | by traveling beam | translation of item |
| 502 | Laser diode | — |
| 504 | Corrective lens | — |
| 506 | Fast-and-slow dimension | Dimension of beam along |
| | wedge | both fast and slow axes |
| 508 | Pitch lens | Pitch of wavefront |
| 510 | Slow dimension wedge | Dimension of beam along slow axis |
| 512 | Yaw lens | Yaw of wavefront |
| 514 | Pitch-yaw spacer | — |
| 516 | Slow-axis fine lens | Fine position of beam along slow axis |
| 518 | Defocus lens | Defocus of beam along slow axis |
| 520 | Fast-axis fine lens | Fine position of beam along fast axis |
| 522 | Slow-axis coarse lens | Coarse position of beam along slow axis |
| 524 | Slow-axis wedge | Axial position of both slow-axis waist |
| 526 | Fast-axis coarse lens | Coarse position of beam along fast axis |
| 528 | Fast-and-slow wedge | Axial position of fast-axis and |
| | | slow-axis waists |
| 530 | Fiber | — |

There are no fixtures required for the optical elements. All the elements have orthogonal faces that mate to each other with optical adhesive. The optical elements also bond directly to the optical base of the system. The optical base is defined by the x-z plane 122 120. Only the diode laser 502 and fiber 530 require fixtures. The diode laser is mounted at an angle as shown. This mount orients the fast axis of the laser diode with the lens y-axis 128.

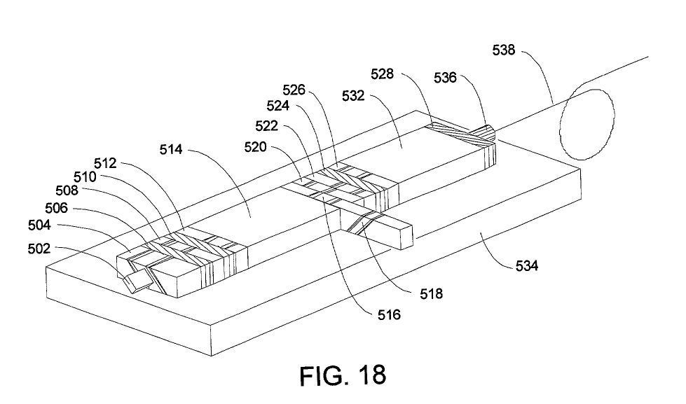

FIG. 18 shows an isometric view of an assembly of a diode-to-fiber pigtailer. The components are mounted on a stable optical base 534. The fiber is displayed in the pigtail format, which includes a ferrule 536 and a pigtail 538. This pigtail is a short length of optical fiber, which is welded to a much longer length of fiberoptic cable. The diode is mounted on a block (not shown) for proper orientation of radial angle. The electrical connections (not shown) to the diode are in the form of an integrated circuit.

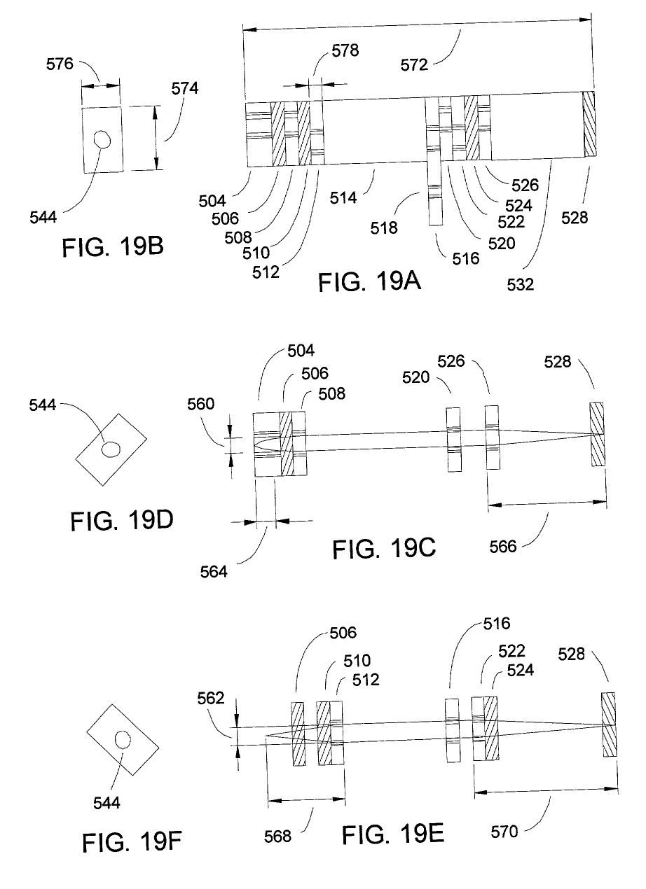

With reference to the specific design for this pigtailer, as shown in FIGS. 19A-F, most of the tags are described in the previous table. Additional tags are cited as necessary. FIG. 19A displays a top view of the assembled device of the laser diode. The corresponding end view is displayed FIG. 19B. A spacer 532 is required for the dead space in between the fast-axis coarse lens 526 and fast-and-slow axial wedge 528. The components move along the long axis of the end view. The end view contains the largest extent 544 of the beam profile.

The design parameters are based a specific laser diode (Thorlabs L9801E2P5) and a typical singlemode fiber. The single mode of the diode is 1 um by 3 um at its exit aperture. Its wavelength is 1 um. The half-angle of divergence along the fast axis is 37 degrees. The numerical aperture, or NA, is the sine of this half-angle. Thus, the NA is 0.6 along the fast axis of the laser diode. Along the slow axis, the half-angle of divergence is 12 degrees, which corresponds to an NA of 0.21.

The half-angle of convergence for the typical singlemode fiber is around 5 degrees, which corresponds to an NA of 0.09. The focal lengths of the collimating and focusing lenses are related to each other by the NAs of the diverging and converging beams.

$$\frac{{f}_{D}}{{f}_{C}} = \frac{{NA}_{C}}{{NA}_{D}}$$

in which f_{D} is focal length of the lens for the diverging beam, f_{C} is focal length of the lens for the converging beam, NA_{C} is the numerical aperture of the converging beam, and NA_{D} is the numerical aperture of the diverging beam. The over all length of the coupling optical is at the very lest equal to the sum of the two focal lengths. The limit of this length is determined by the focal length of the collimating lens for the fast axis of the laser diode. As stated earlier, the minimum focal length of single-axis GRIN lens for collimating the fast axis of laser is 1 mm.

The half-angle of divergence within a refractive medium is reduced by the index of refraction. This is mathematically expressed as

$${α}_{n} = \frac{{α}_{0}}{n} ,$$

in which α₀ is the half-angle of divergence within the refractive, and n is the index of refraction of the refractive medium. The focal length is scaled in a similar manner.

fₙ=nf₀,

in which fₙ is the focal length within the refractive medium, and f₀ is the focal length within vacuum.

FIG. 19C displays a top view of the active elements of the fast axis of the laser diode and a corresponding end view. In this view of the fast axis, the half-angle of divergence at the diode is only 25 degrees because the beam is immersed within a reactive medium. The half-angle of convergence within the refractive medium is 3.5 degrees at the fiber. FIG. 19D displays the corresponding end view to the top view of the fast axis in FIG. 19C.

FIG. 19E displays a top view of the active elements of the slow axis of the laser diode. In this view, the half-angle of divergence of the slow axis is only 8 degrees because the beam is immersed within a reactive medium. The half-angle of convergence within the refractive medium is the same as that of the slow axis, 3.5 degrees at the fiber. FIG. 19F displays the corresponding end view to the top view of the slow axis in FIG. 19E.

The nearly collimated beam within the pitch-yaw spacer displays some astigmatism. The largest dimensions of the two axes of the elliptical profile are displayed as 1.2 mm 560 for the fast axis and 1.4 mm 562 for the slow axis. The slower axis grows to a larger dimension because the collimating lens for the slow axis is separated from the laser diode by the collimating optics for the fast axis. Consequently, the focal length of the collimating lens for the slow axis must be much larger than that for the fast axis.

There are several active elements in the management of the fast axis as displayed in FIG. 19C. The focal length of the corrective lens 504 is 1 to 1.2 mm. The immersion focal length of the corrective lens is displayed as 1.5 mm 564. This lens nearly collimates the beam along the fast axis. The focal length of the pitch lens 508 is 4 to 5 mm. It completes the collimation along the fast axis. The fast-and-slow dimension wedge 506 actively controls the fast-and-slow divergences and the consequential fast-and-slow beam dimensions at the fiber. There are two focusing elements. The coarse fast-axis lens 526 is 6 to 7 mm in focal length. The immersion focal length of the coarse fast-axis lens is displayed as 9.2 mm 566. The fine fast-axis lens 520 is 250 to 500 mm in focal length.

There are several active elements in the management of the slow axis as displayed in FIG. 19E. The focal length of the yaw lens 512 is 4 to 5 mm. The immersion focal length of the yaw lens is displayed as 6 mm 568. It collimates the beam along the slow axis. The fast-and-slow dimension wedge 506 actively controls the fast-and-slow divergences and the consequential fast-and-slow beam dimensions at the fiber. The slow dimension wedge 510 actively controls the slow-axis divergence and the consequential slow-axis beam dimension. There are two focusing elements. The coarse slow-axis lens 522 is 7 to 8 mm in focal length. The immersion focal length of the coarse slow-axis lens is displayed as 11.2 mm 570. The fine slow-axis lens 516 is 250 to 500 mm in focal length.

The thickness of the pitch-yaw spacer block 514 in FIG. 19A is set as 8 mm, which is nearly equal to the focal lengths of the coarse focusing elements. This dimension is not critical as long there is sufficient axial length for radial displacement of the beam by the pitch-yaw elements at the coarse focusing elements.

The pitch-yaw spacer block can also contain a beam splitter for coupling a laser beam from a second diode laser. The beam splitter is a dielectric coating along a plane within the spacer. This plane functions as a folding mirror for the second beam while having essentially no effect upon the first laser beam.

Also, in FIG. 19A, the total length is 27.2 mm 572. The width of the elements along the axis of translation is 5 mm 574. The height of the elements is 3 mm 576. The minimum axial thickness of an element is presently set at 1 mm 578. The axial thickness of the corrective lens 504 is presently set at 2 mm.

The device can be made smaller by several methods. Reducing the focal length of the corrective lens will reduce the other focal lengths. It might be possible to reduce the total length by a factor of 2, which would yield a total length of 14 mm. Removing the spacer 532 for dead air gap will reduce the length by one-third of this spacer's length. Increasing the NA of the fiber will reduce the focal lengths of the focusing lens elements. These embodiments can be assembled by known technology.

Other diode-to-fiber couplers can be made from any balanced combination of the aforementioned compound lenses. The astigmatism of the collimated beam of each half must be identical. This requires an asymmetric combination of compound lenses for a diode-to-fiber coupler. A multitude of combinations of the aforementioned configurations is possible.

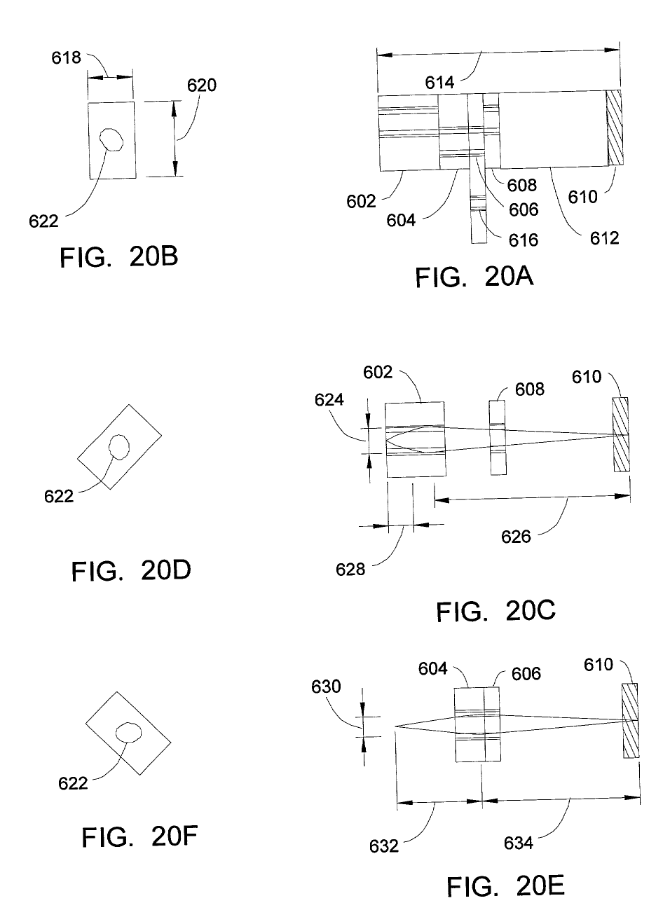

An example of the minimum configuration for coupling a diode-to-fiber coupling is displayed in FIGS. 20A-F. This minimum configuration addresses only three DOFs of the beam at the fiber: the radial position along the fast axis, the radial position along the slow axis, and the axial position of the waist. It has five translating elements that are described as follows.

FIG. 20A is a top view of the device. There are two single-axis relay lenses 602 604 which relay one nearby waist to another. A relay lens does not operate on distant objects. Therefore, the entering and exiting beams both have substantial convergence. These two lenses provide coarse adjustment of the axial position of the beam at the fiber. Two orthogonal weak single-axis lenses 606 608 provide fine adjustment of the radial position of the beam at the fiber. A single wedge 610 controls the axial position of the waist at the fiber. An optional spacer block 612 fills the axial space between the lens elements and the fiber. The axial length 614 of these components is 16.2 mm. There is also a defocusing element 616 incorporated one of the weak lenses 606.

FIG. 20B is end view corresponding to the top view of FIG. 20A. The dimension 618 620 are 3 and 5 mm. The maximum extent of the radial profile 622 is displayed.

FIG. 20C is a top view of the fast axis of the device. Only the effective elements for this axis are shown. The fast-axis relay lens 602 controls the coarse radial position of the beam at the fiber along the fast axis. The fast-axis weak lens 608 controls the fine radial position of the beam at the fiber along the fast axis. The wedge 610 controls the axial position of the waist. The maximum extent of the fast axis profile 624 is 1.7mm. The effective axial distance 626 of the diode waist from the lens is also 1.7 mm. The effective axial distance 628 of the fiber waist from the fast-axis relay lens 602 is 13.1 mm. Application of theses two distances to a simple lens formula indicates an immersion focal length of 1.5 mm. Thus, the effective focal length of the fast-axis relay lens is 1.0 mm. The immersion focal length of the fast-axis weak lens should be 40 times effective axial distance 628 of the fiber waist from the fast-axis relay lens, which specifies the immersion focal length as 350 mm. The focal length in air should be 232 mm. Thus, a range for the focal length of the fast-axis weak lens is 250 to 500 mm. FIG. 20D is end view corresponding to the top view of C.

FIG. 20E is a top view of the slow axis of the device. Only the effective elements for this axis are shown. The slow-axis relay lens 604 controls the coarse radial position of the beam at the fiber along the slow axis. The slow-axis weak lens 606 controls the fine radial position of the beam at the fiber along the slow axis. The wedge 610 controls the axial position of the waist. The maximum extent of the slow axis profile 630 is 1.3 mm. The effective axial distance 632 of the diode waist from the lens is 5.7 mm. The effective axial distance 632 of the fiber waist from the fast-axis relay lens 604 is 10.5 mm. Application of theses two distances to a simple lens formula indicates an immersion focal length of 3.7 mm. Thus, the effective focal length of the slow-axis relay lens is 2.5 mm. The immersion focal length of the fast-axis weak lens should be 40 times effective axial distance 632 of the fiber waist from the slow-axis relay lens, which specifies the immersion focal length as 420 mm. The focal length in air should be 280 mm. Thus, a range for the focal length of the slow-axis weak lens is 250 to 500 mm. FIG. 20F is end view corresponding to the top view of FIG. 20E.

The minimum focal lengths and axial dimensions are based upon the single-axis GRIN elements available from Grintech. Shorter focal lengths and thinner dimension are desirable because the package size becomes smaller. However, this minimum configuration depends upon assembly tolerances for management of the angle the wavefront at the fiber. This angular error is equal to the radial error divided by the total length. It must not exceed 10 mrad. Thus, the total length of this minimum configuration must be at least 100 times the radial error between the diode and the fiber.

Obvious limits to the range of focal lengths and range of dimensions should become apparent to those skilled in the art the fabrication when such experts address the specific needs of this invention. Typically, smaller axial dimensions are desirable at this time because the package size becomes smaller.

Methods For Alignment

Three different methods for alignment are presented for three different types of configurations. These three configurations are: a beam-to-fiber coupler, a fiber-to-fiber coupler, and a diode-to-fiber pigtailer. The methods for each configuration are described.

Method for Beam-To-Fiber

This method is applicable any configuration acting upon a collimated beam. The cited steps apply to the sixth configuration. If a step does not apply to a particular configuration, then the step is omitted without consequence. The alignment procedure for coupling a beam into a fiber is defined as follows. See FIGS. 10, 11, 12, and 13.

1 Defocus beam along x-lens by sliding the defocusing element 414 into the collimated beam.

2 Adjust the coarse y-lens position by translation of the coarse y-lens 404.

3 Slide the fine x-lens 410 into the beam.

4 Adjust the coarse x-lens position by translation of the coarse x-lens 402.

5 Adjust the coarse y-lens position by translation of the coarse y-lens 404.

6 Adjust the pitch by translation of the pitch lens 418.

7 Adjust the yaw by translation of the yaw lens 420.

8 Adjust the z-position of both waist axes by translation of the x-y wedge 406.

9 Adjust the z-position of the y-lens waist by translation of the y-lens wedge 408.

10 Iterate steps 4 through 9.

11 Fix previously translated elements in place.

12 Relieve stress with baking if necessary.

13 Adjust the fine y-lens position by translation of the fine y-lens 412.

14 Adjust the fine x-lens position by translation of the fine x-lens 410.

15 Fix the fine focus elements 410 412 in place.

Method for Fiber-To-Fiber Coupler

This method is applicable the first configuration of a fiber-to-fiber coupler. The alignment procedure of the beam at the fiber is defined as follows. See FIG. 15.

16 Defocus beam along x-lens by sliding the defocusing element 414 into the collimated beam.

17 Adjust the fine y-lens position by translation of the fine y-lens 412.

18 Slide the fine x-lens 410 into the beam.

19 Adjust the fine x-lens position by translation of the fine x-lens 410.

20 Adjust the pitch by translation of the pitch lens 418.

21 Adjust the yaw by translation of the yaw lens 420.

22 Adjust the z-position of the waist by translation of the x-y wedge 406.

23 Adjust the diameter of the waist by translation of the diameter wedge 434.

24 Iterate steps 19 through 23

25 Fix previously translated elements in place.

26 Relieve stress with baking if necessary.

27 Adjust the fine focus along y-lens by translation of the fine y-lens 412.

28 Adjust the fine focus along x-lens by translation of the fine x-lens 410.

29 Fix the fine focus elements 410 412 in place.

Method for Diode-to-Fiber Coupler

This method is applicable the first configuration of a fiber-to-fiber coupler. The alignment procedure of the beam at the fiber is defined as follows. See FIGS. 17, 18, 19.

30 Defocus beam along x-lens by sliding the defocusing element 518 into the collimated beam.

31 Adjust the coarse fast-axis position by translation of the coarse fast-axis lens 526.

32 Slide the fine slow-axis lens 516 into the beam.

33 Adjust the coarse slow-axis position by translation of the coarse slow-axis lens 522.

34 Adjust the coarse fast-axis position the by translation of the coarse fast-axis lens 526.

35 Adjust the pitch by translation of the pitch lens 508.

36 Adjust the yaw by translation of the yaw lens 512.

37 Adjust the axial position of both waist axes by translation of the fast-and-slow axial wedge 528.

38 Adjust the axial position of the slow-axis waist by translation of the slow axial wedge 524.

39 Adjust the fast-and-slow dimensions of both waist axes by translation of the fast-and-slow dimension wedge 506.

40 Adjust the dimension of the slow-axis waist by translation of the slow dimension wedge 510.

41 Iterate steps 33 through 40.

42 Fix previously translated elements in place.

43 Relieve stress with baking if necessary.

44 Adjust the fine fast-axis position by translation of the fine fast-axis lens 520.

45 Adjust the fine slow-axis position by translation of the fine slow-axis lens 516.

46 Fix the fine focus elements 516 520 in place.

Fixation Methods for Free-Space and Fiber-to-Fiber Couplers

The moving elements of free-space and fiber-to-fiber couplers can be held in place by friction against a base plate. The transverse force required for this friction can be managed a variety of spring loaded clamps. A clamp should provide variable force. One magnitude of this force enables translation of the optical elements, while the other strength does not. Fixation of the components is achieved by increasing the force of the transverse clamps. Transverse translation of the locking screws can modify the friction.

The flat end of the elements can be liquid gated to one another. The liquid must fill the interfaces between the elements. An overflow of liquid beyond these interfaces is acceptable because only the axial interfaces are optically active. Actually, the entire optical assembly can be immersed in an index matching fluid.

Fixation Methods for Pigtailing

The diode-to-fiber pigtailer employs a similar liquid gating, which also provides fixation of the optical elements. The liquid gates are optically cured adhesives. There are at least two commercially available varieties of the optical adhesive that are well known to practitioners in the field. One is activated by long ultraviolet wavelengths. The other is cured by short ultraviolet wavelengths. The photons with the long wavelengths have less energy per photon than those with the short wavelengths. Consequently, the long wavelengths do not cure the adhesive that requires the higher energy photons with shorter wavelengths. The long wavelength adhesives can operate in the visible wavelengths of violet and even blue. Therefore, the long- and short-wavelength adhesives are frequently called UV-visible adhesive and UV adhesive respectively. Such adhesives are manufactured by Norland, Dymax, and Epoxy Technologies.

A long-wavelength adhesive such as Norland 72 is employed for the strong optical components while the short-wavelength adhesive such as Norland 61 is used for the weak components optical components. In the aforementioned Method for diode-to-fiber coupler, the strong components are fixed in place by exposure to long-wavelength ultraviolet radiation while the weak components are not fixed by such an exposure. After alignment of the weak components, an exposure to short-wavelength ultraviolet radiation fixes the weak components in place.

Careful application of adhesive is required in this method. The two adhesives should not intermingle. Thus overflow beyond the interfaces must not occur. Numerous possibilities exist for application of adhesives.

A catalytic adhesive can replace the short-wavelength adhesive. Such an adhesive is not cured by exposure to light. However, it does require significant time for fixation.

Computer Controlled Alignment

The present invention provides for automatic alignment controlled by a computer program. The ability to adjust the elements in the optical assemblies described herein along a single translation axis allows for arrangement where the optical elements are mounted on a flat surface. Each element that must be adjusted is connected to a motor controlled by a computer. The mechanical arrangement where all the optical elements are moved back and forth along the same direction simplifies the overall operation where the connections and the attachments to all the movable optical elements are virtually identical. These connections and attachments are well known in the field and may consist of clamps and/or fixtures as described in prior art, referenced herein and/or incorporated by reference materials. In effect only one design is needed and that design is duplicated for each optical element. The optical element, in one embodiment, is positioned via a preloaded, fine threaded lead screw that may be driven via a precision stepping motor or a precision position servo system. The optical element is spring loaded opposed to the lead screw to provide an opposing force to the lead screw force. The lead screw drives the optical element in one direction and the spring drives the element in the opposite direction.

Any of the commercially available computers can be programmed with input/output devices to perform the methods described herein. For example, computer readily available from IBM, Dell, Compaq, Hewlett-Packard can be used. The programs can be formulated in any of several languages, for example, C, C++, Java, Pascal, and even assembly languages for the Pentium and/or Alpha and other well-known computer chips.

In each case a sensor device is used to measure the light output of the receiving fiber, as described herein. Such sensors are well known in the art. These sensing devices must be connected to the computer being used via I/O ports that are also well known in the art. Often the sensors will provide a digital output that can be input to the computer directly. Other sensors may need an analog to digital converter (ADC), which is interfaced to provide a digital signal to the computer, again as is well known in the art. Also, as described herein the operations may be repetitively performed to optimize the positioning of the optical elements.

Although positioning of the optical elements may be accomplished more efficiently under computer control, the positioning may be performed manually. In such a case, the light coupled into the fiber is measured by a detector at the output of the fiber. This detector may even be the human eye

What is claimed is:

1. A compound lens arranged to intersect a beam of light, the beam of light having a first beam and a second beam, both of which are external to the compound lens, wherein the first beam has an absolute convergence less than or equal to the absolute convergence of the second beam, the compound lens comprising:
a first one-axis lens that defines a first axis of focus oriented at a first radial angle, the first one-axis lens adjacent to the first beam,
a second one-axis lens that defines a second axis of focus oriented at a second radial angle, wherein the first and the second radial angles are not equal or opposite to each other, the second one-axis lens adjacent to the first one-axis lens and optically coupled to the first one-axis lens, and the second one-axis lens adjacent to the second beam, and
means for translating the first one-axis lens and the second one axis lens, independently, each along a single translation direction that defines a third radial angle, wherein the third radial angle is not equal or opposite to either of the first or the second radial angles.

2. The compound lens as defined in claim 1 wherein a fourth radial angle formed by the first and the second axes of focus is about ninety degrees, and the single translation direction approximately bisects the fourth radial angle.

3. The compound lens as defined in claim 1, further comprising a first optical wedge positioned within the second beam, and means for moving the first optical wedge along the single translation axis.

4. The compound lens as defined in claim 1, further defining one of the first or the second beams as an exiting beam and wherein the exiting beam defines orthogonal beam waists, comprising a second optical wedge within the beam between the first and second one-axis lens elements, and means for moving the second optical wedge along the single translation direction, wherein the moving creates substantial axial shift of one exiting orthogonal beam-waist.

5 The compound lens as defined in claim 1 further comprising a second compound lens placed to intersect the first or the second beams, the second compound lens comprising:
a third one-axis lens that defines a third axis of focus oriented at a third radial angle,
a fourth one-axis lens that defines a fourth axis of focus oriented at a fourth radial angle, the fourth one axis lens adjacent to the third one-axis lens and optically coupled to the third one-axis lens, and wherein the third and the fourth radial angles are not equal or opposite to each other or to the single translation direction, and
means for translating the third and the fourth one-axis lenses, independently, along the single translation direction, wherein the moving of the third and the fourth one-axis lenses provides an improved optical leverage to the compound lens..

6. The compound lens as defined in claim 5 wherein the focal lengths of the third and the fourth one-axis lenses are about forty times those of the first and second one-axis lenses, wherein the third and fourth lenses provides an improved optical leverage to the compound lens by about 40 times.

7. The compound lens as defined in claim 1, wherein one of the first or the second beams is a beam entering the compound lens and the other is an exiting beam, the compound lens further comprising:
a fifth one-axis lens having a fifth focal axis, the fifth one-axis lens located to intersect the first or second beam, and
means for moving the fifth one-axis lens along the single translation direction, wherein such moving spreads the exiting beam across the focal axis of the fifth lens.

8. The compound lens as defined in claim 1 further comprising a sixth one-axis lens placed in the first or the second beams to eliminate the astigmatism of the compound lens within the first or the second beam,

9. The compound lens as defined in claim 1 further comprising any combinations and permutations of optical elements selected from the group of the optical elements consisting of a) a first optical wedge positioned within the second beam; b) a second optical wedge positioned between the first and the second one-axis lens elements; c) a third one-axis lens that defines a third axis of focus oriented at a third radial angle and a fourth one-axis lens that defines a fourth axis of focus oriented at a fourth radial angle, the fourth one-axis lens placed adjacent to the third one-axis lens, the fourth one-axis lens optically coupled to the third one-axis lens, and wherein the third and the fourth radial angles are not equal or opposite to each other or to the single translation axis, the third and the fourth one-axis lenses placed in either the first or the second beams; d) a fifth one axis lens placed in the first or second beam, and e) a sixth one-axis lens placed in the first or the second beams.

10. A compound lens arranged to intersect a beam of light comprising:
a two-axis lens that defines a first beam and a second beam, both of which are external and adjacent to the two-axis lens and wherein the first beam has an absolute convergence less than or equal to the absolute convergence of the second beam,
a first one-axis lens that defines a first axis of focus oriented at a first radial angle,
a second one-axis lens that defines a second axis of focus oriented at a second radial angle, wherein the first and the second radial angles are not equal or opposite to each other, wherein the first and the second one-axis lenses are adjacent and optically coupled to each other, and wherein the adjacent first and second one axis lenses are within the first or the second beams, and
means for translating the first and the second one-axis lenses along a single translation direction that defines a third radial angle, wherein the third radial angle is not equal or opposite to either of the first or the second radial angles.

11. The compound lens as defined in claim 10 wherein a fourth radial angle formed by the first and the second axes of focus is about ninety degrees, and the single translation axis approximately bisects the fourth radial angle.

12. The compound lens as defined in claim 10 further comprising:
a first optical wedge positioned within the second beam, and means for moving the first optical wedge along the single translation direction.

13. The compound lens as defined in claim 10 further comprising:
a third one-axis lens defining a third focal axis positioned within the first or the second beams, and
means for moving the third one-axis lens along the single translation direction, wherein such moving spreads the exiting beam across the focal axis of the third lens.

14. The compound lens as defined in claim 10 further comprising any combinations and permutations thereof of optical elements selected from the group consisting of: a) a first optical wedge positioned within the second beam, b) a first one-axis lens that defines a first axis of focus oriented at a first radial angle; c) a second one-axis lens that defines a second axis of focus oriented at a second radial angle, the second one axis lens placed adjacent to the first one-axis lens, the second one axis lens optically coupled to the first one-axis lens, and wherein the first and the second radial angles are not equal or opposite to each other or to the single translation axis, the first and the second one-axis lenses placed in either the first or the second beams; and d) a third one-axis lens defining a third focal axis positioned within the first or the second beams.

15. A relay lens for coupling a beam of light, the beam of light defining a first beam that exits an optical source and a second beam that enters an optical sink, wherein both beams are external to the relay lens, the relay lens comprising:
a first compound lens as defined in any of the preceding claims, and
a second compound lens as defined in any of the preceding claims, wherein the first and the second compound lenses are arranged so that first beam of the first compound lens is the first beam of the second compound lens

16. A relay lens for coupling a beam of light, the beam of light defining a first beam that exits an optical source and a second beam that enters an optical sink, the second beam defining orthogonal beam waists, wherein both beams are external to the relay lens, the relay lens comprising:
a first one-axis lens that defines a first axis of focus oriented at a first radial angle, the first one axis lens arranged to receive the first beam and output a third beam,
means for moving the first one-axis lens back and forth along a translation direction
a second one-axis lens that defines a second axis of focus oriented at a second radial angle, the second one-axis lens arranged to receive the third beam and output a fourth beam, and wherein the first and the second radial angles are not equal or opposite to each other,
means for moving the second one-axis lens back and forth along the translation direction,
a third one-axis lens that defines a third axis of focus oriented at a third radial angle, the third one-axis lens arranged to receive the fourth beam and output a fifth beam,
means for moving the third one-axis lens back and forth along the translation direction,
a fourth one-axis lens that defines a fourth axis of focus oriented at a fourth radial angle, the fourth one-axis lens arranged to receive the fifth beam and output the second beam, and wherein the third and the fourth radial angles are not equal or opposite to each other, and
means for moving the fourth one-axis lens back and forth along the translation direction;
wherein the moving of the first and second one-axis lenses adjusts the axial angles of the beam entering the sink; and
wherein the moving of the third and fourth one-axis lenses adjusts the radial positions of the beam entering the sink

17. The relay lens as defined in claim 16 further comprising:
an optical spacer positioned between the second and the third one-axis lenses arranged to intersect the fourth beam, wherein the optical spacer reduces the effects of moving the first or second one-axis lenses upon the radial position of the beam entering sink;
a first optical wedge placed between the optical source and the first one-axis lens arranged to intersect the first beam
means for moving the first optical wedge back and forth along the translation direction, wherein moving the first optical wedge modifies both orthogonal radial dimensions of the beam waist entering the sink,
a second optical wedge placed between the optical sink and the fourth one-axis lens arranged to intersect the second beam,
means for moving the second optical wedge back and forth along the translation direction, wherein moving the second optical wedge provides equal translations of the orthogonal beam waists entering the sink,
a third optical wedge placed between the first and the second one-axis lenses,
means for moving the third optical wedge back and forth along the translation direction, wherein moving the third optical wedge substantially modifies one of the orthogonal dimensions of the beam waist entering the sink,
a fourth optical wedge placed between the third and the fourth one-axis lenses,
means for moving the fourth optical wedge back and forth along the translation direction, wherein moving the fourth optical wedge adjusts the axial position of one orthogonal beam waist entering the sink,
a fifth one-axis lens that defines a fifth axis of focus oriented at a fifth radial angle, the fifth one-axis lens positioned after the spacer and before the third one-axis lens, means for moving the fifth one-axis lens back and forth along the translation direction,
a sixth one-axis lens that defines a sixth axis of focus oriented at a sixth radial angle, the sixth one-axis lens positioned between the fifth one-axis lens and the third one-axis lens, and wherein the fifth and the sixth radial angles are not equal or opposite to each other,
means for moving the sixth one-axis lens back and forth along the translation direction,
wherein the moving of the fifth and sixth one-axis lenses have similar effects to the moving of the third and fourth one-axis lenses but with different optical leverages compared to the moving of the third and fourth one-axis lenses;
a seventh one-axis lens abutted to the fifth one-axis lens within the same axial space,
wherein the means for moving the fifth one-axis lens also moves the seventh one-axis lens, wherein the moving of the seventh one-axis lens into the beam spreads the beam waist at the sink across the focal axis of the seventh one-axis lens, and
an eighth one-axis lens placed to intersect the first beam, wherein the lens complements the range of astigmatism of the relay lens.

18. A relay lens for coupling a beam of light, the beam of light defining a first beam that exits an optical source and a second beam that enters an optical sink, wherein both beams are external to the relay lens, the relay lens comprising:
a first two-axis lens that receives the first beam and outputs a third beam that is nearly collimated,
a first one-axis lens that defines a first axis of focus oriented at a first radial angle, the first one axis lens arranged to receive the third beam and output a fourth beam,
means for moving the first one-axis lens back and forth along a radial translation direction
a second one axis lens that defines a second axis of focus oriented at a second radial angle, the second one-axis lens arranged to receive the fourth beam and output a fifth beam, and wherein the first and the second radial angles are not equal or opposite to each other,
means for moving the second one-axis lens back and forth along the radial translation direction, and
a second two axis lens arranged to receive the fifth beam and output the second beam.

19. A relay lens for coupling a beam of light from an optical source to an optical sink, the beam of light defining a first beam that exits an optical source and a second beam that enters an optical sink, wherein both beams are external to the relay lens, the relay lens comprising:
a first optical wedge that receives the first beam and outputs a third beam, and means for moving the first optical wedge back and forth along a radial translation direction,
a first two-axis lens that receives the third beam and outputs a fourth beam that is nearly collimated,
a first one-axis lens that defines a first axis of focus oriented at a first radial angle, the first one axis lens arranged to receive the fourth beam and output a fifth beam,
means for moving the first one-axis lens back and forth along the radial translation direction,
a second one-axis lens that defines a second axis of focus oriented at a second radial angle, the second one-axis lens arranged to receive the fifth beam and output a sixth beam, and wherein the first and the second radial angles are not equal or opposite to each other and not equal to the translation direction,
means for moving the second one-axis lens back and forth along the radial translation direction,
an optical spacer that receives the sixth beam and output a seventh beam,
a third one-axis lens that defines a first axis of focus oriented at a third radial angle, the third one axis lens arranged to receive the seventh beam and output an eighth beam,
means for moving the third one-axis lens back and forth along the radial translation direction,
a fourth one axis lens that defines a fourth axis of focus oriented at a fourth radial angle, the fourth one-axis lens arranged to receive the eighth beam and output a ninth beam, and wherein the third and the fourth radial angles are not equal or opposite to each other and not equal to the translation direction,
means for moving the fourth one-axis lens back and forth along the radial translation direction,
a second two axis lens positioned to receive the ninth beam and output a tenth beam,
a second optical wedge positioned to receiver the tenth beam and output the second beam, and
means for moving the second wedge lens back and forth along the radial translation direction.
wherein moving the first optical wedge modifies both orthogonal radial dimensions of the beam waist entering the sink,
wherein moving of the first and second one-axis lenses adjusts the axial angles of the beam entering the sink;
wherein the optical spacer reduces the effects of moving the first or second one-axis lenses upon the radial position of the beam entering sink;
wherein moving of the third and fourth one-axis lenses adjusts the radial position of the beam entering the sink; and
wherein moving the second optical wedge modifies the axial position of both beam-waists entering the sink

20. A method for aligning a beam of light with an optical lens assembly, the beam defining an optical axis, the method comprising the steps of:
defining an x-y axes coordinate system orthogonal to the optical axis,
defining an exiting and an entering beam with respect to the lens assembly,
first deflecting the beam exiting a compound lens with respect to the x axis by moving back and forth, along a single radial translation direction, a first one-axis lens that defines a first focal axis oriented at a first radial angle,
second deflecting the beam exiting a compound lens with respect to the y axis by moving back and forth, along the single radial translation direction, a second one-axis lens that defines a second focal axis oriented at a second radial angle, wherein the first and the second focal axes are not parallel with each other or the translation direction.

21. The method as defined in claim 20 further comprising the steps of:
intersecting the exiting beam with a first optical wedge, and
moving the exiting beam waist along the optical axis by translating the first optical wedge back and forth along the single translation direction.

22. The method as defined in claim 20 further comprising the steps of:
intersecting the beam between the first and the second one-axis lens with a second optical wedge, and
if the beam is traveling from the first to the second one-axis lenses, moving axially the exiting beam waist oriented across the focal axis of the first one-axis lens by translating the second optical wedge, but if the beam is traveling from the second to the first one-axis lenses, moving axially the exiting beam waist oriented across the focal axis of the second one-axis lens by translating the second optical wedge, wherein the translation of the optical wedges is back and forth along the single translation direction.

23. The method as defined in claim 20 further comprising the steps of:
intersecting the entering beam with a second compound lens having focal length much larger that the focal length of the first compound lens,
first fine deflecting the beam exiting the lens assembly with respect to the x axis by moving back and forth, along a single radial translation direction, a first one-axis lens that defines a first focal axis oriented at a first radial angle,
second fine deflecting the beam exiting a compound lens with respect to the y axis by moving back and forth, along a single radial translation direction, a second one-axis lens that defines a second focal axis oriented at a second radial angle, wherein the first and the second focal axes are not parallel with each other or the translation direction.

24. The method as defined in claim 23 further comprising the step of defining the focal lengths of the third and the fourth one-axis lenses to be about forty times the focal lengths of the first and the second one-axis lenses.

25. The method as defined in claim 20 further comprising the steps of:
intersecting the first beam with a fifth one-axis lens, and
translating the fifth one-axis lens along the translation axis wherein the second beam is spread across the focal axis of the fifth one-axis lens.

26. The method as defined in claim 20 further comprising the step of intersecting the entering or the exiting beam with a sixth lens to correct for astigmatism of the lenses.

27. A compound lens arranged to intersect a beam of light, the beam of light defining a first beam and a second beam, both of which are external to the compound lens and wherein the first beam has an absolute convergence less than or equal to the absolute convergence of the second beam, the compound lens comprising:
a first one-axis lens, wherein the first one-axis lens defines a first axis of focus oriented at a first radial angle,
means for translating the first one-axis lenses back and forth along a first radial translation direction not parallel to the focal axis of the first one-axis lens,
a second one-axis lens placed adjacent to the second beam, wherein the second one-axis lens defines a second axis of focus oriented at a second radial angle, wherein the first and the second radial angles are not equal or opposite to each other, and
means for translating the second one-axis lenses back and forth along a second radial translation direction not parallel to the focal axis of the second one-axis lens and not parallel to the first radial translation direction.

28. A one-axis lens that defines a focal axis that is oriented at a first radial angle, the one-axis lens comprising a radial flat plane surface and an axial flat plane surface, wherein the radial and the axial flat plane surfaces meet defining a straight line, and wherein the line defines a radial direction of travel such that when the one-axis lens is moved along this line it moves across the focal axis of the one-axis lens.

29. A lens of claim 28 having a refractive-index graded along a radial direction normal to its focal axis, and having a second radial flat plane surface for bonding to a third radial flat plane of another lens.
